(19) United States
(12) Patent Application Publication
(10) Pub. No.: US 2011/0189971 A1
(43) Pub. Date: Aug. 4, 2011

(54) SYSTEM AND METHOD FOR PACKETIZED EMERGENCY MESSAGES

(76) Inventors: Stefano Faccin, Hayward, CA (US); Johanna Lisa Dwyer, Ottawa (CA); Mark Earnshaw, Ottawa (CA); Takashi Suzuki, Tokyo (JP); Stephen McCann, Southhampton (GB); Venkata Ratnakar Rao Rayavarapu, Slough (GB); Jan Hendrik Lucas Bakker, Irving, TX (US); Chen Ho Chin, Deerlijk (BE)

(21) Appl. No.: 12/698,956

(22) Filed: Feb. 2, 2010

(51) Int. Cl. H04M 11/04; H04W 4/00

(52) U.S. Cl. 455/404.1; 455/466

(57) ABSTRACT

A system and method allows for providing emergency service, whether the service is full or limited, to wireless devices using non-IMS packet traffic based methods or Access Stratum/Non-Access Stratum (AS/NAS) signalling based methods. To do so, a system and method for utilizing a Packetized Emergency Message (PEM) is provided.

### BACKGROUND

The present disclosure relates generally to systems and methods for communications between a wireless device and a network and, more particularly, to systems and methods for communicating information related to emergencies in a packetized form.

As used herein, the term wireless device can refer to a variety of wireless devices such as mobile telephones, personal digital assistants (PDAs), handheld or laptop computers, and similar devices, including user equipment (UE), user agent (UA), or mobile stations (MS) that have telecommunications capabilities. In some configurations, a wireless device may refer to a mobile, wireless device. The term wireless device may also refer to devices that have similar capabilities but that are not generally transportable, such as desktop computers, set-top boxes, or network nodes.

A wireless device may operate in a wireless communication network that provides high-speed data and/or voice communications. For example, the wireless device may operate in accordance with one or more of an Evolved Universal Terrestrial Radio Access Network (E-UTRAN), Universal Terrestrial Radio Access Network (UTRAN), Global System for Mobile Communications (GSM) network, Evolution-Data Optimized (EV-DO), Digital Enhanced Cordless Telecommunications (DECT), Digital AMPS (IS-136/TDMA), Integrated Digital Enhanced Network (iDEN), Universal Mobile Telecommunications System (UMTS), Enhanced Data rates for GSM Evolution (EDGE), GSM/EDGE Radio Access Network (GERAN) and General Packet Radio Service (GPRS) technology. Other wireless networks that wireless devices may operate in include but are not limited to Code Division Multiple Access (CDMA), cdma2000, cdma2000 1xRTT, cdma2000 HRPD, WLAN (e.g. IEEE 802.11) and WRAN (e.g. IEEE 802.22), Wireless Personal Area Networks (PAN), Bluetooth, ZigBee and Wireless Metropolitan Area Networks (MAN) (e.g., WiMAX, IEEE 802.20). Wireless devices may also operate in fixed network environments such as, for example, Digital Subscriber Line (xDSL) environments, Data Over Cable Service Interface Specification (DOCSIS) cable networks, or optical networks. Within the context of this document, it is assumed that any non-3GPP radio access technology, has access (through interworking) to a 3GPP specified core network.

Referring to FIG. 1, a communications system 10 includes a wireless device 12, a wireless network 14, and a Public Safety Answering Point (PSAP) 16. The PSAP 16 is associated with or includes a second device referred to at times hereafter as an answering point device. The wireless device 12 is configured to communicate through the wireless communication network 14 and other en route networks to the PSAP 16.

Traditionally, communication with the PSAP 16 must pass through a Public Switched Telephone Network (PSTN) 18. However, in some situations, communications with the PSAP 16 may occur over other networks 20. For example, support of emergency voice calls over internet protocol (IP) Multimedia Subsystem or IM CN Subsystem (IMS) is provided using 3GPP-specified radio access technologies, such as GERAN, UTRAN, or E-UTRAN or other non-3GPP radio access technologies. However, support of emergency voice calls over IMS using 3GPP-specified radio access technologies requires, among other constraints, IMS to be supported in the core network and it would be advantageous if IMS Voice over packet switched (PS) (IMSVoPS) is supported in the access network. In addition, in accordance with some Enhanced or Evolved Packet Core (EPC) protocols, IMS emergency services, both originating and (where required by regulator in jurisdiction) PSAP call back session for wireless devices attached to the EPC via 3GPP-specified radio access technologies (and non-3GPP radio access technologies), are only provided to a wireless device if the wireless device is attached in a non-limited service mode, without getting authenticated by the network. This requires that the wireless device be camped on a cell that meets a variety of requirements, such as belonging to an allowed Public Land Mobile Network (PLMN), not being part of a forbidden local area (LA), and the like.

Evolved Packet Systems (EPS), such as E-UTRAN or UTRAN radio access networks and the EPC, in some situations, will permit support of IMS emergency services to a wireless device that has not successfully attached to the network, for example, because no cells belonging to an allowed Public Land Mobile Network (PLMN) are available or the wireless device cannot authenticate to the PLMN. Thus, under certain conditions, EPS will therefore permit support of IMS emergency services to a wireless device in “limited service state.”

Where emergency calls using IMS are not supported in the current serving cell, emergency calls may be realized by one of the following: using non-IMS services, such as circuit-switched voice on the current Radio Access Technology (RAT), if supported; falling back from E-UTRAN to a legacy 3GPP RAT and using non-IMS voice services; reselecting from E-UTRAN to a legacy 3GPP RAT; and falling back to a non-3GPP RAT. The need for such “fallback” methods may be avoided by way of a camping policy so that an appropriate serving cell is selected. However, currently, E-UTRAN does not support voice services, including emergency calls, other than by way of IMS.

The need for support of emergency calls in the core network (CN) subsystem is determined by, for example, national regulatory requirements. A circuit switched (CS) and IMS capable wireless device 12 follows the conventions and rules specified in 3GPP TS 22.101 and 3GPP TS 23.167 to select the domain for the emergency call attempt. If the CS domain is selected, the wireless device 12 can attempt an emergency call setup using appropriate access technology specific procedures. As described above, in Release 8, there is no support for the wireless device 12 making an emergency call from the “camped on any cell” state, since this causes a mobile to be in “limited service” state. An IMS-capable wireless device 12 that is able to camp normally on a cell (i.e. without any conditions that result in limited service state) in a network supporting IMS, accesses IMS emergency services by initiating the initial attach procedure. The wireless device 12 requests a Packet Data Network (PDN) connection for emergency services (if an emergency PDN connection is not already active) by indicating Request Type “Emergency” and optionally including the emergency Access Point Name (APN).

Emergency bearer services are provided by the serving network 20 when the network is configured to support emergency services. A Mobility Management Entity (MME) is configured with MME Emergency Configuration Data that are applied to all emergency bearer services that are established by the MME based on a request from a wireless device 12 or, if the emergency PDN is used for an “immediate” PSAP session, call back while the emergency bearer is still “up.” If a PDN gateway is not explicitly included in the MME Emergency Configuration Data, the MME Emergency Configuration Data contains the Emergency APN, which can be used to derive a PDN gateway. The MME Emergency Configuration Data supersedes any wireless device subscription data received from the Home Subscriber Server (HSS) relating to emergency bearer services.

As Release 8 EPS does not support IMS emergency calls from limited services state, Release 8 compliant wireless devices are not permitted to camp in limited service state on E-UTRA cells. Instead such wireless devices select a UTRAN/GERAN cell on which to camp in limited service state and can then perform an emergency call in the CS domain because CS domain emergency calls are always possible in UTRAN/GERAN networks, even when the mobile is in limited service state.

From Release 9 and beyond, wireless devices will be able to camp in limited service state on E-UTRA cells, if supported by the network. The E-UTRA cells that have been upgraded to support IMS emergency calls from limited services state and are connected to a core network that supports IMS emergency calls will broadcast an “IMS emergency call over E-UTRA” indicator, and may broadcast an IMSVoPS indicator. If a wireless device is in limited service state and needs to access emergency services, then the wireless device initiates the Attach procedure indicating that it is attaching to receive emergency services. This procedure is also known as an Emergency Attach. When the network is configured to support emergency services for wireless devices in limited service state and to provide IMS emergency calls (i.e. it supports Voice over IP and may or may not broadcast the IMSVoPS indicator), it provides emergency bearer services to this wireless device, regardless of whether the wireless device can be authenticated, has roaming or mobility restrictions, or a valid subscription. Therefore, the authentication and security setup is skipped, it is accepted that authentication and security setup may fail, or security setup using “null” security algorithms is initiated. If the MME is not configured to support Emergency Attach, then the MME will reject this attempt by the wireless device. An emergency attached wireless device shall not initiate any PDN Connectivity Request procedure in order to add other PDN connections besides the emergency one. For emergency attached wireless devices, MME initiated implicit detach procedures are based on a specific emergency inactivity timer.

With this background in place, following hereafter, a number of situations will be addressed, whereby, undesirable conditions are experienced by the user of the wireless device, the network, and/or the emergency service. In some instances, though conditions are not lacking, the conditions could be improved or enhanced.

Mobility During Emergency Support in IMS Over EPS

For any 3GPP access that is to connect to the EPC (GERAN, UTRAN, and E-UTRAN), there are a number of considerations regarding mobility. In the specific example of E-UTRAN, when the E-UTRAN Radio Access Bearer (E-RABs) for emergency bearers are established, the Allocation and Retention Priority (ARP) values for emergency bearer services indicate the usage for emergency services to the E-UTRAN. The E-UTRAN takes this into consideration during mobility when evaluating handover target cells. When a wireless device needs to be handed over to another cell, and only restricted target cells are available (that is, target cells which the wireless device is not allowed to access because the wireless device cannot be authenticated, does not have a valid subscription for the target cell, or has roaming or mobility restrictions related to accessing this cell, such as a cell belonging to a forbidden tracking area), the emergency radio access bearer can still be handed over while all the other radio access bearers are released. If only emergency bearers are allowed to be handed over, the source MME requests that the target MME only create emergency bearers in the target cell. An IMS emergency session may be handed over to a Home NodeB/Home eNodeB (HNB/HeNB), assuming that VoIMS (VoIP over IMS) is supported in order to allow voice.

During Tracking Area Update procedures, the target MME ignores any mobility or access restrictions for the wireless device with emergency bearer services where required by local regulation. However, any non-emergency bearer services are deactivated by the target MME when not allowed by the subscription for the target location. Thus, the wireless device will be left in a situation where, though originally having full access when starting the communication with the emergency service, the wireless device is now restricted to only being able to access emergency services.

For an IMS emergency call, a PSAP should make a call towards a “tel” (telephony) uniform resource identifier (URI) or a Session Initiation Protocol (SIP) URI or GRUU (SIP URI including a ‘gr’ parameter), so if the wireless device moves to another access network and registers in that network with the same or equivalent tel URI or a SIP URI (implicitly or explicitly) or is contacted using the same GRUU, the wireless device can receive the call back over normal bearers in the new network.

Mobility during an emergency should be adequately supported; however, the method by which the wireless device alerts the network to an emergency may vary across the network. For example, the method by which the wireless device alerts the network to an emergency may vary because IMS Voice over PS was supported where the emergency call was originally placed, but as the wireless device moves, it enters areas where this type of call is no longer supported.

Furthermore, in many instances, the preferred networks for emergency services may be GERAN/UTRAN, but the wireless device may be in an area of only E-UTRAN coverage, with no IMS support in either the core network or wireless device, so an IMS emergency call as a second alternative is also not possible. With no GERAN/UTRAN coverage, currently there is no way for an emergency call to be supported.

Further still, the wireless device may be in E-UTRAN without access to voice services at all due to lack of network support for IMS emergency voice calls, a failed combined attach/TAU (Tracking Area Update) with no CS fallback available, or the combined attach/TAU succeeded for SMS-only (Short Message Service) such as when there are no CS fallback services available including voice and the wireless device is “Data Centric,” such as a laptop data card with VoIMS support. Again, in these instances, there is no way for an emergency call to be supported.

In addition, in order to enable the wireless device to connect to different PSAPs for different types of emergencies, in the EPC the correct PDN gateway (P-GW) needs to be selected to connect to the desired PSAP. In GPRS, the correct GGSN (Gateway GPRS Support Node) needs to be selected for the same reason. The GGSN/P-GW can have a list of preconfigured addresses of application layer servers or signalling servers (e.g. P-CSCF servers). In current systems, the wireless device can already indicate the type of emergency upon attach so that the correct GGSN can be selected to connect to the correct PSAP. However, the following problems persist. First, in GERAN/UTRAN it is not possible for the wireless device to provide information specific to the current emergency when additional PDN connectivity is established, such as when a new IP (Internet Protocol) connection is added to carry emergency traffic. Second, in EPC/E-UTRAN it is not possible for the wireless device to provide information specific to the current emergency both upon attach and upon an additional PDN connection being established, again such as when a new IP connection is added to carry emergency traffic. Moreover, if a solution existed for the previous points, when the wireless device is connected to a first PDN for a first emergency service, such as communicating with the police, if the wireless device needs to connect to a second emergency service, such as a fire service, either after the first connection is over or in parallel, the wireless device cannot assume that the PDN connectivity and the PDN gateway for the first emergency service will allow it to reach the correct PSAP for the second emergency service. Further still, in EPC mechanisms for non-3GPP accesses, it is not possible for the wireless device to provide information specific to the current emergency upon attach (assuming this is provided in order to allow the establishment of PDN connectivity to the correct PDN gateway) and upon an additional PDN connection being established, such as when a new IP connection is added to carry emergency traffic. Specifically, when an S2c interface (Interface with Trusted or Un-trusted non-3GPP Access) is used to provide connectivity over a non-3GPP access, there is no mechanism that allows the wireless device to provide an indication of the type of emergency in order to enable the selection of the correct PDN gateway.

Situational Influences that affect the method of Establishing an Emergency Communication Session

For most wireless devices in most situations, there may be more than one way to establish an emergency communication session with a network. In some cases, the choice of the method used to establish an emergency communication session is influenced or even determined based on situational influences. Some examples of situational influences are as follows.

When there is no overlap of the coverage of E-UTRAN and other fall-back RATs (e.g. UTRAN and GERAN), there are situations where the wireless device is being served by the E-UTRAN but an emergency call cannot be established in E-UTRAN using IMS, for example, and no other RATs are currently available. In this case, another method for emergency call establishment must be used.

Also, when a wireless device or core network has support for IMS and IMS based emergency calls, the wireless device support for IMS and IMS based emergency calls is fixed; however, the core network support for this could change on a cell-by-cell basis. Thus, a wireless device may change cells and another method for emergency call establishment would need to be used in the target cell. Similarly, when a wireless device or core network has support for CS fallback, the fallback may cause another method for emergency call establishment to be needed.

Also, the camping status of the wireless device affects how emergency notification to the network may be established. For example, when a wireless device is camped normally, the wireless device may be attached with default PDN connectivity. However, the wireless device may be camped and attached normally but only on EPC (i.e. Combined attach rejected) and not on a fallback RAT network. In this case, CS fallback requires the wireless device to have performed a successful combined registration/attach procedure. In addition, the wireless device may be in a limited service state (camped on any PLMN cell) and, hence, have no default PDN connectivity.

Complicating things further still, the wireless device may not support voice calls, for example, in the case of a wireless data-only device, such as data cards for some computer systems. In all cases, however, emergency notification still must be able to be realized by the wireless device.

Emergency Type Specific PSAP Connectivity

In several countries there is the need to be able to connect the wireless device to different PSAPs for different types of emergencies, such as, police, ambulance, and the like. This functionality has been in the 3GPP specifications for C Emergency Calls (TS12) since Rel-4. The requirement states, “It shall be possible to initiate emergency calls to different emergency call centers, depending on the type of emergency. The following types of emergency calls shall be possible:
Police
Ambulance
Fire Brigade
Marine Guard
Mountain Rescue

The implementation of this requirement may be found in later revisions, which detail the Service Category IE Service category including a Emergency Category. The Emergency Category is used only during call setup, but it is not used when additional connectivity (i.e. new PDP (Packet Data Protocol) contexts) are established for GERAN/UTRAN. Hence, an informational shortcoming may be realized over what could otherwise have been communicated.

In addition, the Internet Engineering Task Force (IETF) has documented a series of service URNs. Some service URNs are emergency service URNs. Some ‘sos’ service URNs and ‘counseling’ service URNs are documented in IETF RFC 5031 as follows:

urn:service:sos is the generic ‘sos’ service reaches a public safety answering point (PSAP), which in turn dispatches aid appropriate to the emergency. It encompasses all of the services listed below.

urn:service:sos.ambulance is the service identifier that reaches an ambulance service that provides emergency medical assistance and transportation.

urn:service:sos.animal-control Animal control typically enforces laws and ordinances pertaining to animal control and management, investigates cases of animal abuse, educates the community in responsible pet ownership and wildlife care, and provides for the housing and care of homeless animals, among other animal-related services.

urn:service:sos.fire is the ‘fire’ service identifier summons the fire service, also known as the fire brigade or fire department.

urn:service:sos.gas The ‘gas’ service allows the reporting of natural gas (and other flammable gas) leaks or other natural gas emergencies.

urn:service:sos.marine is the ‘marine’ service refers to maritime search and rescue services such as those offered by the coast guard, lifeboat, or surf lifesavers.

urn:service:sos.mountain is the ‘mountain’ service refers to mountain rescue services (i.e., search and rescue activities that occur in a mountainous environment), although the term is sometimes also used to apply to search and rescue in other wilderness environments.

urn:service:sos.physician is the ‘physician’ emergency service connects the caller to a physician referral service.

urn:service:sos.poison is the ‘poison’ service refers to special information centers set up to inform citizens about how to respond to potential poisoning. These poison control centers maintain a database of poisons and appropriate emergency treatment.

urn:service:sos.police is the ‘police’ service refers to the police department or other law enforcement authorities.

urn:service:counseling is the generic ‘counseling’ service reaches a call center that transfers the caller based on his or her specific needs.

urn:service:counseling.children is the ‘children’ service refers to counseling and support services that are specifically tailored to the needs of children. Such services may, for example, provide advice to run-aways or victims of child abuse.

urn:service:counseling.mental-health is the ‘mental-health’ service refers to the “diagnostic, treatment, and preventive care that helps improve how persons with mental illness feel both physically and emotionally as well as how they interact with other persons”. (U.S. Department of Health and Human Services)

urn:service:counseling.suicide is the ‘suicide’ service refers to the suicide prevention hotline.

Accordingly, it can be seen that there are a wide variety of scenarios that can arise due to the above situational influences, may of which are problematic. For example, in many of the above-described scenarios, it is not possible for a wireless device to access voice emergency services using the conventional means specified in the 3GPP standards, by either IMS or CS fall back. It is also possible that traditional scenarios do not apply in all cases, e.g. in case of ‘kidnap’ and ‘terror attack’ situations both the network and the wireless device support IMS/non-IMS voice emergency services and adequate radio coverage is available, but the traditional emergency services (i.e. voice emergency calls) are not preferable. In such emergency scenarios periodic transmission of PEM with positioning, mobility information can act as a beacon for tracing the requestor of emergency

Thus, there is a need for systems and methods that address the above-listed issues and allow access to emergency services for wireless devices in the situations described above and other situations.

### BRIEF DESCRIPTION OF THE DRAWINGS

In the accompanying drawings, like reference numerals represent like parts or operations.

FIG. 1 is an illustration of an example schematic diagram of a wireless device and associated network;

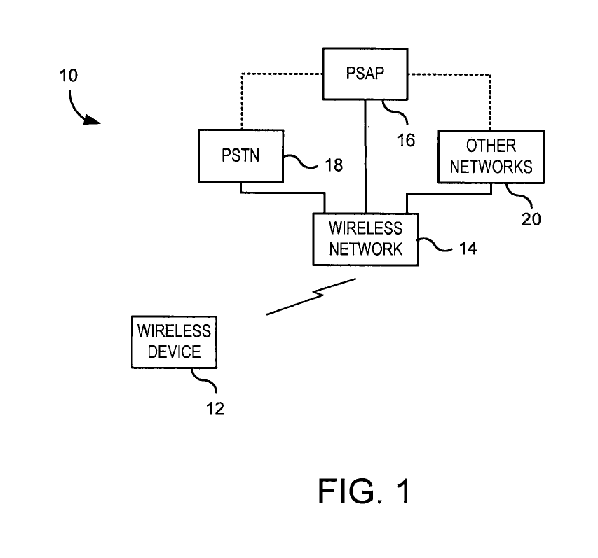

FIG. 2 is a flow chart setting forth some exemplary steps of a method for utilizing Packetized Emergency Messages (PEMs);

FIG. 3 is an illustration of an example schematic diagram of a wireless device and associated network configured to utilize PEMs;

FIG. 4 is a table illustrating one example of a PEM table;

FIG. 5 is an illustration of an example schematic diagram of an architecture for communicating PEMs in conjunction with Unstructured Supplementary Service Data (USSD) protocols;

FIG. 6 is an illustration of an exemplary block diagram of the wireless device; and

FIG. 7 illustrates a software environment that may be implemented by a processor of a wireless device.

### DETAILED DESCRIPTION

The present disclosure provides a method of communicating a packetized emergency message (PEM) from a wireless device to a packetized emergency message consumer (PEMC). The method includes receiving an indication that PEM is supported via one of short message service (SMS) and a unstructured supplementary service data (USSD), discovering an address of a PEMC, and transmitting the PEM to the PEMC via the at least one of SMS and USSD.

The present disclosure also provides a method of communicating a packetized emergency message (PEM) from a wireless device over a network to a packetized emergency message consumer (PEMC). The method includes identifying a PEM for transmission from the wireless device to a PEMC connected to the network using a signaling system #7 (SS7) protocol and, using an unstructured supplementary service data (USSD) protocol, transmitting the PEM to the PEMC.

The present disclosure additionally provides a method of communicating a packetized emergency message (PEM) from a wireless device over a network to a packetized emergency message consumer (PEMC). The method includes identifying a PEM for transmission from the wireless device to a PEMC, identifying an address of the PEMC, and transmitting the PEM to the PEMC using a short message service (SMS) protocol.

The present disclosure also provides a wireless device configured to communicate a packetized emergency message (PEM) from the wireless device to a packetized emergency message consumer (PEMC). The wireless device includes a processor configured receive an indication that PEM is supported via one of short message service (SMS) and a unstructured supplementary service data (USSD), discover an address of a PEMC, and transmit the PEM to the PEMC via the at least one of SMS and USSD.

The various aspects of the disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (for example, hard disk, floppy disk, magnetic strips, and the like), optical disks (for example, compact disk (CD), digital versatile disk (DVD), and the like), smart cards, and flash memory devices (for example, card, stick, and the like). Additionally, it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

The present disclosure provides a system and method for providing emergency service, whether the service is full or limited, to wireless devices using IMS or non-IMS packet traffic based method or Access Stratum/Non-Access Stratum (AS/NAS) signalling based method. In an IMS packet traffic based method, some IMS or SIP functional elements or proxies or severs are used. Before detailing such systems and methods, it is noted that the present disclosure introduces various concepts that will be identified as follows. Initially, a definition of a Packetized Emergency Message (PEM) is provided. However, before addressing these definitions, it is noted that, in the following description, terms specific to E-UTRAN are used, for example, terms like MME, PDN connection, and the like. The description, however, applies also to other 3GPP RATs, for example, the RNC (Radio Network Controller) or the SGSN (Serving GPRS Support Node) can be used instead of the MME, and a PDP context can be used instead of the PDN connection.

A used herein, the term “PDN Connection” is intended to refer to either PDN Connections established over GERAN/UTRAN or E-UTRAN or a non-3GPP RAT (e.g. WLAN) using the Evolved Packet Core (EPC) network, or to PDP Contexts established over GERAN/UTRAN in case of a GPRS network.

Definition of the Packetized Emergency Message (PEM) in EPS

The PEM is a specialized data packet constructed during an emergency situation by a wireless device. The construction of this PEM data packet may be triggered based on user input or on situational analysis by the wireless device and not requiring any user intervention. As will be described, the PEM is designed to provide autonomous packetized emergency notification from the wireless device to the network, thus, providing the PSAP or a PEM Consumer (PEMC) with more information about the nature of the emergency, the nature of the victim of the emergency, or other useful information at a time when having this information might cause the PSAP or a PEMC or its operator(s) to act in different manners.

It is noted that, while the PEM is primarily intended to support the wireless device that does not have the ability to make emergency calls over IMS or to supplement the emergency calls with the information contained in the PEM, or to provide an alternative to emergency calls for IMS, it is also possible to use the PEM as part of an IMS emergency call in addition to e.g. voice or video media or in place of voice or video media. In fact, the PEM may be a SIP MESSAGE request or an SMS or Unstructured Supplementary Service Data (USSD). The address to be used to route and/or mark the message as PEM can be well-known and could, for example, be an IETF defined address such as “urn:service:sos.PEM,” for example, when the SIP MESSAGE request is sent. Or one or more such addresses could be registered with a registrar such as IANA. Further still, a wireless device can be provisioned to transmit the PEM to one or more PEMCs, for example, such as may be caused by an operator, a regulator or PSAP operator, or other.

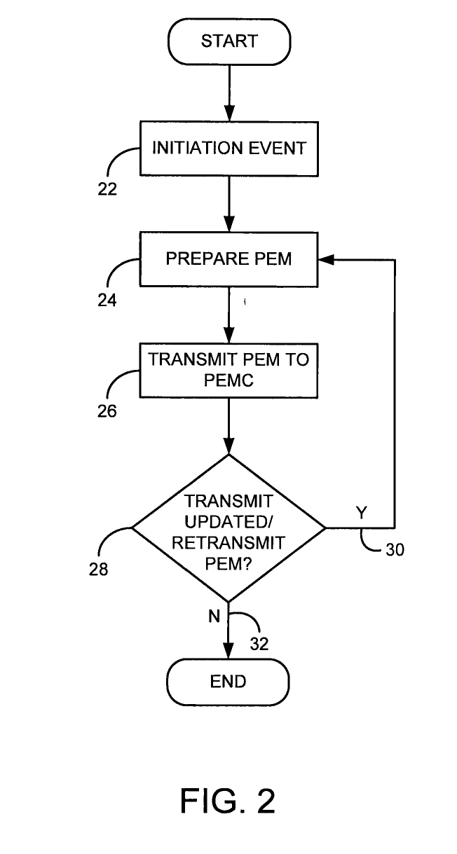

Referring to FIGS. 2-4 and, initially, FIG. 2, a process for utilizing PEMs for emergency communications begins upon an initiation event, as indicated at process block 22. The initiation event could be the start of an emergency situation, such as upon initial emergency call establishment or the user triggering a non-voice emergency service e.g. by pressing a button on the wireless device, or by an application running on the wireless device. Also, the PEM could be resent upon different mobility events, such as change in cell, change in routing or tracking area, and the like. The PEM could also be resent based on user input or triggering at the wireless device.

After the initiation event, the PEM is prepared for transmission at process block 24. Preparation for transmission may include any or all of a number of processes. For example, preparation may be as little as preparing a precompiled message for transmission. Alternatively, preparation may include data collection and compilation into a PEM. For example, the type of information to be included in the PEM and, in particular, the fields, whether all PEMs must contain the same information or whether a first PEM needs to contain all the required information and the following ones can only contain a subset of the information, and the conditions under which the wireless device can send the PEM can be configured in the wireless device. The configuration may be done, for example, by the network operator or another party providing such information to the wireless device using e.g. a Management Object (MO), or by the owner of the PEMC (PEM Consumer) and a variety of other methods, such as direct input to the wireless device during wireless device setup or as part of the UUIC card (popularly known as SIM or USIM) or RUIM.

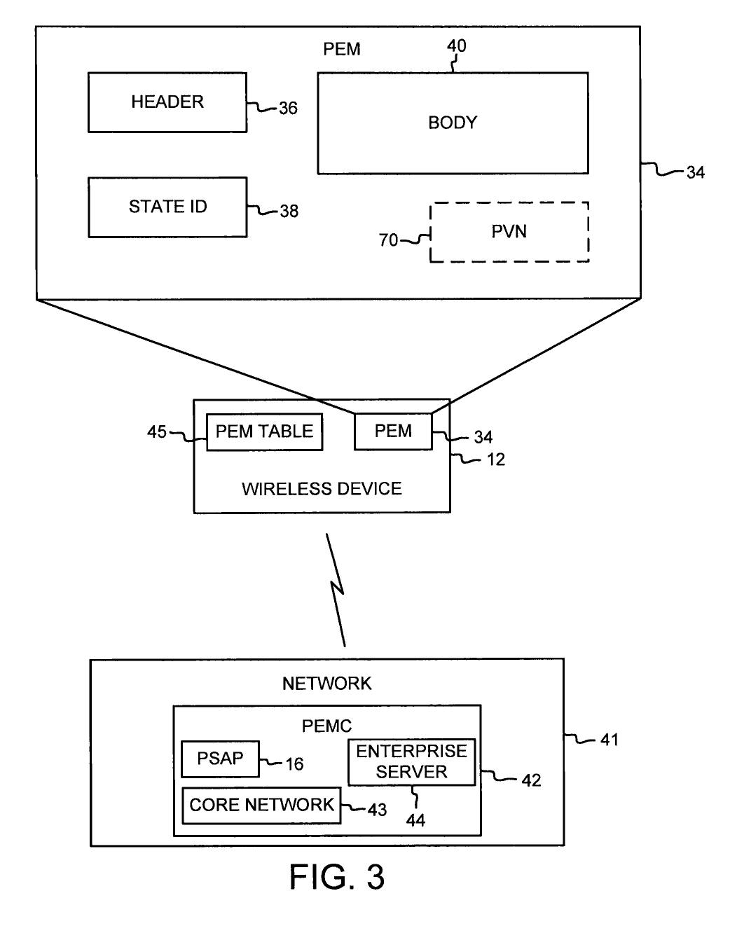

Referring to FIG. 3, an exemplary PEM 34 may include a header 36 identifying the wireless device. For example, identifying information may include International Mobile Equipment Identity (IMEI), Personal Identification Number (PIN), International Mobile Subscriber Identity (IMSI), Temporary Mobile Subscriber Identity (TMSI), home Public Land Mobile Network (PLMN) (HPLMN), Phone Number, Globally Routable UA URI (GRUU), a Private User Identity, all known Public User Identities, and the like or a combination of any such information.

The PEM 34 may also contain a mechanism, such as a state ID 38, designed to identify the wireless device as being a wireless device in limited service state, such as not capable of authenticating itself in the current PLMN or not having a SIM card. In such cases, the PEM can contain only a subset of the information above. For example, in the case of a wireless device that is incapable of authenticating itself, the wireless device may still provide the IMEI, IMSI, and HPLMN information, or a specific indication that allows the network to identify the wireless device as unauthenticated, such as by providing a well-known value of IMEI or IMSI. In addition, if the limited service state is a temporary state, then providing identities that can be used to reach the wireless device when it enters normal state may also be advantageously provided. A (visited) network operator may be compelled to “grant” a wireless device in confirmed distress a “normal” state. The PEM may also contain information that identifies the “Emergency access point” that is being contacted. This can be done in a specialized unique header, or in a field of a new message type.

A body 40 of the PEM can include other details relating to the wireless device including, for example, the position details, such as provided by Global Positioning System (GPS) location or other positioning measurement information, or any other detail that provides information related to wireless device location. An optional field can indicate the type of emergency that is being communicated, such as fire, medical, and the like in order to solicit the most appropriate response message. In addition, via the user interface (e.g. MMI) some personal medical information field may be stored on the wireless device or on removable memory, such as a medical-alert type information that may detail pre-existing conditions. This information may be included in the PEM as well.

Referring again to FIG. 2, once preparation of the PEM 34 is complete, the PEM 34 is sent to the recipient at process block 26. Specifically, as illustrated in FIG. 3, the PEM 34 is sent by the wireless device 12 to an entity in a network 41 that utilizes the information contained in the PEM 34, referred to here in as a PEM Consumer (PEMC) 42. An example of a PEMC 42 is a PSAP 16 or a core network 43. Another example of a PEMC 42 is an enterprise server 44 configured to receive PEM 34 information from a wireless device 12 that belongs to the enterprise and is configured to send a PEM 34 to the enterprise under specific conditions that were part of the initiation event and configured in the wireless device 12.

Referring again to FIG. 2, in some instances, it may be desirable to retransmit or update the PEM 34, as indicated at decision block 28, so that the changes in details of the wireless device, for example, change in position, are identifiable in the messages. In the event of a “large” initial PEM, such as a PEM that includes a voice note, as will be described below, these periodic follow-up transmissions may be of a reduced size and, for example, may include a reference or “pointer” to the initial PEM, in order to reduce the over-the-air resources that would be required and still allow for the PEM stored in the network 41 to remain valid. If it is determined at decision block 28 that a retransmission or updated PEM should be transmitted 30, the process reiterates. Otherwise, if at decision block 28 it is determined that no retransmission or update is necessary 32, the process ends.

Rather than including large data such as a voice note or one or more other or additional forms of media, the PEM could include a reference such as a hyperlink or URL. FTP or HTTP or other protocols could then be used retrieve the media that may have been previously recorded and stored. For example, medical information could be transmitted by reference as opposed to by value. A server (e.g. in the network or hosted by a third party or located elsewhere) could maintain and make available relevant information if referenced during an emergency call or emergency service. As pointed out above, a PEM could include one or more references to (relevant) information.

In either of the above two cases, ciphering and, if required, authentication can be by-passed based on the various establishment causes specified at AS and NAS levels. If the existing establishment causes do not allow the provision of a packetized emergency service or for bypassing the security, then spare values where available can be used to define a new cause suitable for this service. For example, an establishment cause in the Release 8 RRC (Radio Resource Control) Connection Request message has three spare values and may be used for this purpose. This may be needed, for example, to better support unauthenticated wireless devices.

Simultaneous Transmission of PEM to Multiple PEMCs

As described above, under specific conditions, such as different types of emergencies like fires, car accidents, and the like, the wireless device 12 can be configured to send the PEM to multiple PEMCs, for example, the PSAP 16 and a PEMC in the enterprise 44. Also, the wireless device 12 can be configured to send PEMs to different PEMCs simultaneously, each at the same time and with the same frequency or with different frequency or under different conditions per each PEMC.

For UTRAN/GERAN in GPRS, the concepts apply in the same way for PDP contexts that provide connectivity between the wireless device and one or more GGSNs. For E-UTRAN and non-3GPP RATs (e.g. WLAN) in EPS, the concepts apply in the same way for PDN Connections that provide connectivity between the wireless device and one or more GGSNs. If the PEM is sent over PDN connections as described below, the wireless device may send the PEM(s) destined to different PEMCs over the same PDN connection or over different PDN connections. The network may ‘fork’ a (single) PEM and transmit PEMs to multiple PEMCs. The network may be configured with these PEMC addresses (and e.g. translate “urn:service:sos.PEM” into one or more PEMC (addess(es)) and/or the device may include more than one PEMC addresses. The wireless device 12 can be configured by the operator or the enterprise owning the wireless device 12 to know how and when to send multiple PEMs.

As will be described, if the control plane is used to transmit the PEM towards the PSAP 16, the wireless device 12 will use a PDN connection, either the default one or a dedicated PDN connection, to send the PEM to the additional PEMC 42. The wireless device 12 can send parallel PEMs to multiple PEMCs 42 in both synchronous and asynchronous scenarios with control-plane transmission. However, as will be described, the wireless device 12 can send parallel PEMs to multiple PEMCs 42 in both synchronous and asynchronous scenarios with control-plane and user-plane transmission.

It is noted that PEMs sent to different PEMCs 42 may contain different types of information. The configuration information that the wireless device 12 has may include the particular information that should be included in the PEM so that the information can be differently set between the network operator and the other of other PEMCs 42, such as the enterprise server 44.

Referring back to FIG. 2, the transmission of the PEM to the PEMC illustrated in process block 26 can occur using a variety of mechanisms. For example, as will be described below, the transmission of the PEM can be on the user plane or the control plane or a combination. As will be described, the PEM may be a SIP MESSAGE request or an SMS or over USSD or SIP PUSH or otherwise.

Transmission of PEM on User Plane

The PEM 34 in EPC can be sent on a specially established PDN connection for emergency services. The attach cause, RRC connection establishment cause, and the PDN connection request type will determine the establishment of a PDN connection based on the specific APN provided by the wireless device or an indication of the type of emergency service provided by the wireless device. The PEM 34 can also be sent on a default PDN connection (e.g. if that is preferred for the network 41).

The PEM 34 can be sent in UTRAN/GERAN in GPRS using a PDP Context and in E-UTRAN and non-3GPP RATs (e.g. WLAN) in EPC using PDN Connections. This includes the following scenarios. First, for example, the wireless device 12 may request one or more PDN connections for the transmission of the PEM 34 and possibly provide an indication to identify the PDN connection as a PDN connection for emergency services. Second, for example, the wireless device 12 may request one or more Secondary PDP Contexts or one or more additional PDN connections for the transmission of the PEM 34 and possibly provide an indication to identify the secondary PDP context or additional PDN connection as a secondary PDP context or PDN connection for emergency services. Third, for example, the network 41 may establish one or more PDP contexts on behalf of the wireless device. In such scenarios, the wireless device 12 may provide, during the establishment of an emergency PDN connection or secondary PDP context, an indication of the type of emergency service, and the network 41 may decide that further PDP contexts, secondary PDP contexts or additional PDN connections are required to provide the appropriate connectivity.

The PEM 34 can be sent as a session-less message or session-based message. In the former case, the wireless device 12 starts sending the PEMs 34 to the PEMC 42 without first exchanging any signalling with the PEM 34. In the latter case, the wireless device 12 exchanges signalling with the PEMC 42 to establish a session. The signalling can be as an example SIP signalling or IMS signalling exchanged between the wireless device and the PEMC or the PSAP.

In the case of periodic resending of the PEM 34, the periodicity of the message can be included in the original PEM 34. This will inform the network 41 of the periodicity on which the emergency PDN connection needs to be re-established, such that it does not need to be maintained throughout the emergency but can be released after the original call is completed. If the emergency PDN connection is re-established periodically, then PDN gateway relocation would be needed at each periodic interval since the wireless device may have moved away from the original location where the attach and establishment of the emergency PDN connection took place.

Alternatively, a Guaranteed Bit Rate (GBR) bearer in one of the existing PDN connections may be established for the PEM transmission, if such PDN connection provides connectivity to the desired PEMC 42. However, the PDN gateway that the wireless device 12 is connected to may lead to a PDN that does not give access to the PSAP 16, so this would not be suitable in all cases. If the PEM 34 is to be sent periodically, then the network 41 may periodically establish the bearer without additional signalling. Another option is that a new bearer type could be defined and utilized.

If the PEM 34 is sent over a PDN connection, then the wireless device 12 discovers a destination IP address in order to know where to send the PEM 34. It is noted that, in emergency calls with IMS over E-UTRAN, the wireless device 12 is provided with the IP addresses that should be used, but requires IMS or SIP functionality in the wireless device 12 and in the network 41. However, the wireless device 12 may need to discover the addresses of multiple PEMCs 42 or (SIP) signalling server such as P-CSCFs in case the wireless device 12 needs to be able to send PEMs 34 to multiple or particular PEMCs 42. PEMCs 42 may be of different types, such as public PEMCs 16 or private like a PEMC in the enterprise 44, and may be applicable to a given wireless device 12 depending on emergency type and/or location and/or other factors. The wireless device 12 may therefore discover one PEMC 42 for each PDN connection used by the wireless device 12 to send PEMs 34 or, if the wireless device 12 uses a single PDN connection to send PEMs 34 to multiple PEMCs 42, the wireless device 12 may discover multiple PEMCs 42 accessible via the same PDN connection. The wireless device may discover multiple of these single PDN connection to send PEMs 34 to multiple PEMCs 42.

A number of options are provided for the wireless device 12 to discover the destination IP address or signalling server IP address or both and, thus, where to send the packet. First, standardized, well-known unicast address may be preconfigured in the wireless device 12. This allows the network 41 to have a variety of PEMC 42 in the network 41, with the first one “picking up” the PEM 34 and consuming it, and indicating back to the wireless device 12 that this PEMC 42 can be used. It is noted that it is not clear if unicast addressing is currently supported on regular PDN connections, so a specific PDN connection capable of supporting anycast addressing may be used. In this case, this can be an emergency PDN connection as defined for the support of IMS voice emergency, or a PDN with a specific APN that enables the support of anycast addressing. Second, the wireless device 12 may discover the PEMC 42 address similarly to the way the wireless device 12 discovers a Proxy Call Session Control Function (P-CSCF) when connecting, with the wireless device 12 using Dynamic Host Configuration Protocol (DHCP), or being preconfigured, or returned to the wireless device 12 during the establishment of the PDN connectivity. Also, the wireless device 12 may use a well-known logical name Full Qualified Domain Name (FQDN) configured in the wireless device 12 such as Directory Name Service (DNS) or may use an FQDN returned by the network 41 to the wireless device 12 during the establishment of the PDN connectivity. In the case that the PEM 34 is sent over IMS, the address could be well-known and could be an IETF defined and Internet Assigned Numbers Authority (IANA) registered address, such as “urn:service:sos.PEM.” The SIP MESSAGE would be transmitted to a P-CSCF. The P-CSCF would be configured to be able to resolve the logical Uniform Resource Name (URN) into an actual address and/or to forward the SIP request via intermediate IMS network elements such as e.g. an IMS application server, S-CSCF, E-CSCF, etc. The wireless device in addition can use SIP signaling or IMS signaling exchanged with a server, such as a P-CSCF in the IMS infrastructure, to discover the address of the PEMC to be used to forward PEMs to. The wireless device can indicate to the signaling server the type of emergency service required by providing an indication of the emergency service category (e.g. fire, ambulance, PEM, and the like) in order for the network to provide the address of one or more PEMCs.

For example, for emergency services the network, based on the Emergency Service Category IE the wireless may have provided, can, for example, perform one or more of the following actions or other actions. The following is by way of example and a variety of messages and message types may be used. The network includes in ACTIVATE DEFAULT EPS BEARER CONTEXT REQUEST the Emergency Service Category IE to indicate whether the emergency services and which emergency services (e.g. PEM) are reachable through the PDN Connection. Also, the network can include in ACTIVATE DEFAULT EPS BEARER CONTEXT REQUEST the Emergency Service Priority IE if the network wants to indicate the priority of the PDN Connection regarding the emergency services reachable through the PDN Connection. In addition, the network can include in ACTIVATE DEFAULT EPS BEARER CONTEXT REQUEST the Emergency Service Requested IE if the network wants to indicate to the wireless device that the emergency service supported (e.g. PEM) shall be provided over this PDN Connection in addition to other PDN Connection the UE may be using for the emergency service. Moreover, the network can include in ACTIVATE DEFAULT EPS BEARER CONTEXT REQUEST the list of emergency service servers in the Emergency Servers indication if the network wants to indicate to the wireless device, which emergency service servers are available. This list can contain a set of emergency server addresses and; thus, can be an IP address or an FQDN corresponding to the Emergency Service Category provided by the GGSN. Further still, the network can include in ACTIVATE DEFAULT EPS BEARER CONTEXT REQUEST an Emergency Service Periodicity IE if the Emergency Service Category IE indicates a non-IMS voice emergency service and the network wants to indicate the emergency service requires a periodic transmission. Also, the network can include in ACTIVATE DEFAULT EPS BEARER CONTEXT REQUEST the PEM Information indication if the Emergency Service Category IE indicates the emergency service is PEM. Also, the network includes in the ACTIVATE DEFAULT EPS BEARER CONTEXT REQUEST the Emergency Number List containing a list of emergency numbers, for example a list of MSISDNs, The network includes the Emergency Number list for example if the Emergency Service Category indicates PEM over SMS is supported to provide the MSISDN of the PEM recipient.

To implement such, the existing Emergency Service Category is derived from the Emergency Category information element defined in 3GPP TS 24.008 by extending it to include new emergency categories. In a first example, the Emergency Service Category may be composed as a sequence of 8 characters “0” or “1” mapped from the Emergency Service Category Value (octet 3) in the Emergency Category, where the meaning is:

Bit 1 Police

Bit 2 Ambulance

Bit 3 Fire Brigade

Bit 4 Marine Guard

Bit 5 Mountain Rescue

Bit 6 manually initiated eCall

Bit 7 automatically initiated eCall

Bit 8 Packetized Emergency Message

When the Emergency Service Category is provided by the wireless device to the network, the wireless device may set one or more bits to “1” to indicate which emergency services are requested. If more than one bit is set to “1”, in the response the network provides emergency information required to support the types of emergency services requested by the wireless device. In addition, if more than one bit is set to “1”, the MME can select a PDN GW or the SGSN can select a GGSN that enables connection to a combined Emergency centre (e.g. ambulance and fire brigade in Japan) or to both types of Emergency centres.

If no bit is set to “1”, the MME or SGSN can select a default emergency PDN GW or GGSN for the emergency service.

When the Emergency Service Category is provided by the network to the wireless device, the network, for example the MME or the SGSN, can set one or more bits to “1” in order to indicate the emergency service or emergency services supported.

In a second example, the Emergency Service Category may be composed as a sequence of 9 characters “0” or “1” mapped from the Emergency Service Category Value (octet 3) in the Emergency Category, where the meaning is:

Bit 1 Police

Bit 2 Ambulance

Bit 3 Fire Brigade

Bit 4 Marine Guard

Bit 5 Mountain Rescue

Bit 6 manually initiated eCall

Bit 7 automatically initiated eCall

Bit 8 Packetized Emergency Message via PDP context or PDN connection

Bit 9 Packetized Emergency Message via SMS

When the Emergency Service Category is provided by the wireless device to the network, the wireless device may set one or more bits to “1” to indicate which emergency services are requested. If more than one bit is set to “1”, in the response the network provides emergency information required to support the types of emergency services requested by the wireless device. In addition, if more than one bit is set to “1”, the MME can select a PDN GW or the SGSN can select a GGSN that enables connection to a combined Emergency centre (e.g. ambulance and fire brigade in Japan) or to both types of Emergency centres.

If no bit is set to “1”, the MME or SGSN can select a default emergency PDN GW or GGSN for the emergency service.

When the Emergency Service Category is provided by the network to the wireless device, the network, for example the MME or the SGSN, can set one or more bits to “1” in order to indicate the emergency service or emergency services supported. If the “Packetized Emergency Message via PDP context or PDN connection” bit is set to “1”, if the wireless device needs to send a PEM the wireless device shall use the PDP context or PDN connection to send the PEM and discover the appropriate PEMC using the mechanisms defined for the PEM transport over the user plane. If the “Packetized Emergency Message via SMS” bit is set to “1”, if the wireless device needs to send a PEM the wireless device shall use SMS to send the PEM. If the “Packetized Emergency Message via SMS” bit is set to “1”, the network shall provide in the Emergency Number List the address of the PEMC to be used or a list of PEMC addresses that can be used, for example in the format of an MSISDN. If the wireless device is capable of using both SMS at NAS level and SMS over IMS, the wireless device decided whether to send the PEM using SMS at the NAS level or SMS over IMS based on operator preferences and/or user preferences. If the “Packetized Emergency Message via PDP context or PDN connection” bit is set to “1” and the “Packetized Emergency Message via SMS” bit is set to “1”, if the wireless device needs to send a PEM the wireless device decides whether to send the PEM via PDP context or PDN connection or to send the PEM via SMS.

The length contains the number of octets used to encode the Emergency Service Category Value and the Number digits. The number digit(s) in octet 5 precedes the digit(s) in octet 6 etc. The number digit, which would be entered first, is located in octet 5, bits 1 to 4. The contents of the number digits may be coded as shown in table 10.5.118 of 3GPP TS 24.008. If the emergency number contains an odd number of digits, bits 5 to 8 of the last octet of the respective emergency number shall be filled with an end mark coded as “1111”.

In a another example, the Emergency Service Category may be composed as a sequence of 10 characters “0” or “1” mapped from the Emergency Service Category Value (octet 3) in the Emergency Category, where the meaning is:

Bit 1 Police

Bit 2 Ambulance

Bit 3 Fire Brigade

Bit 4 Marine Guard

Bit 5 Mountain Rescue

Bit 6 manually initiated eCall

Bit 7 automatically initiated eCall

Bit 8 Packetized Emergency Message via PDP context or PDN connection

Bit 9 Packetized Emergency Message via SMS at NAS level

Bit 10 Packetized Emergency Message via SMS over IMS

If the “Packetized Emergency Message via PDP context or PDN connection” bit is set to “1”, if the wireless device needs to send a PEM the wireless device shall use the PDP context or PDN connection to send the PEM and discover the appropriate PEMC using the mechanisms defined for the PEM transport over the user plane. If the “Packetized Emergency Message via SMS at NAS level” bit is set to “1”, if the wireless device needs to send a PEM over SMS the wireless device shall use SMS at NAS level, for example SMS over NAS in GERAN and UTRAN, or SMS over SGs in E-UTRAN, in order to send the PEM. If the “Packetized Emergency Message via SMS over IMS” bit is set to “1”, if the wireless device needs to send a PEM over SMS the wireless device shall use SMS over IMS.

If the “Packetized Emergency Message via SMS” bit is set to “1” or if the “Packetized Emergency Message via SMS over IMS” bit is set to “1”, the network shall provide in the Emergency Number List the address of the PEMC to be used or a list of PEMC addresses that can be used, for example in the format of an MSISDN for SMS via NAS and SMS over IMS, or in the format of a url for SMS over IMS.

If the wireless device is capable of using both SMS at NAS level and SMS over IMS, the wireless device decides whether to send the PEM using SMS at the NAS level or SMS over IMS based on operator preferences and/or user preferences.

Thus, with respect to the Emergency Service Category, the network can include this IE if the network wants to indicate which emergency services (e.g. PEM) are reachable through the PDP context or PDN Connection. The Emergency Service Priority can be included if the network wants to indicate to the MS the priority of the PDP context or PDN Connection regarding the emergency services reachable through the PDP context or PDN Connection. When deactivating PDP contexts or PDN Connection, the wireless device or the network can consider the Emergency Service Priority of each emergency PDP context or PDN Connection in order to select the PDP context or PDN Connection with the lowest priority first. Regarding the Emergency Service Requested, this IE can be included if the network wants to indicate to the wireless device the specific emergency services that can be provided over this PDP context or PDN Connection in addition to other PDP context or PDN Connection the wireless device may be using for the emergency service. The Emergency Servers IE can be included if the network wants to indicate to the wireless device the list of emergency service servers containing a set of emergency server addresses (this can be an IP address or an FQDN) corresponding to the Emergency Service Category provided by the GGSN. The Emergency Service Periodicity can be included if the network wants to indicate to the wireless device the emergency service periodicity if the Emergency Service Category indicates a non-IMS voice emergency service requiring periodic transmission of information The PEM Information IE can be included if the network wants to indicate to the wireless device the PEM Information if the Emergency Service Category indicates the emergency service is PEM.

There are a number of approaches to handle these situations. For example, when the wireless device 12 establishes a PDN connection, including upon attach, or PDP context, the wireless device 12 is notified, among the various parameters it receives upon attach or establishment of an additional PDN connection, of whether a PEMC 42 is reachable through this PDN connection. For each PDN connection established, the wireless device 12 stores, in a PEMC table 45, an indication of which of the active PDN connections provide connectivity to a PEMC 42. When a PDN is disconnected, the wireless device 12 verifies if it was using that PDN connectivity to send the PEM 34 and, in such a case, the wireless device 12 may select another PDN from the PEMC table 45. In the case that none of the remaining active PDN connections allow the PEMC 42 to be reached, the wireless device 12 may establish an additional PDN connection such as an emergency PDN connection and use it for sending the PEM 34. Second, when the wireless device 12 receives the information on whether the PDN connection gives access to the PEMC 42, the wireless device may also receive an indication of priority. Thus, when multiple PDN connections are available to connect to a PEMC 42, the wireless device 12 can choose one of those with the highest priority. Third, the network 41 can also indicate, when a PDN connection is created, whether the wireless device 12 can send the PEM 34 on such PDN connection, since multiple PEMCs may be provided in different PDNs. An example is a wireless device 12 that is connected over a first PDN connection to the operator core network 43, and over a second PDN connection directly to the enterprise server 44, and both the operator core network 43 and the enterprise server 44 desire to receive the PEM 34. In this case, the wireless device 12 uses the PEMC table 45 of the active PDN connections over which the wireless device 12 must send the PEM 34, possibly together with the priority described above.

If multiple types of PEMC 42 exist, it is possible that the wireless device 12 is also provided the types of the PEMC 42 that are reachable and that the wireless device 12 associates in the PEMC table 45. Also the type of PEMCs reachable on each PDN connection may be included in the PEMC table 45. Alternatively, only the reachability of public PEMCs 42, such as PEMC in a PSAP 16, may be indicated to the wireless device 12, whereas reachability of other PEMCs 42, such as enterprise server PEMC 44, may be indicated to the wireless device 12 or may be configured in the wireless device 12 for the various PDNs. In the case that the PEM 34 is sent using IMS and the PEMC 42 has a SIP address, it can be reached over an existing PDN connection, and establishing a dedicated PDN gateway to reach the PEMC would, in this case, cause additional delay and complexity.

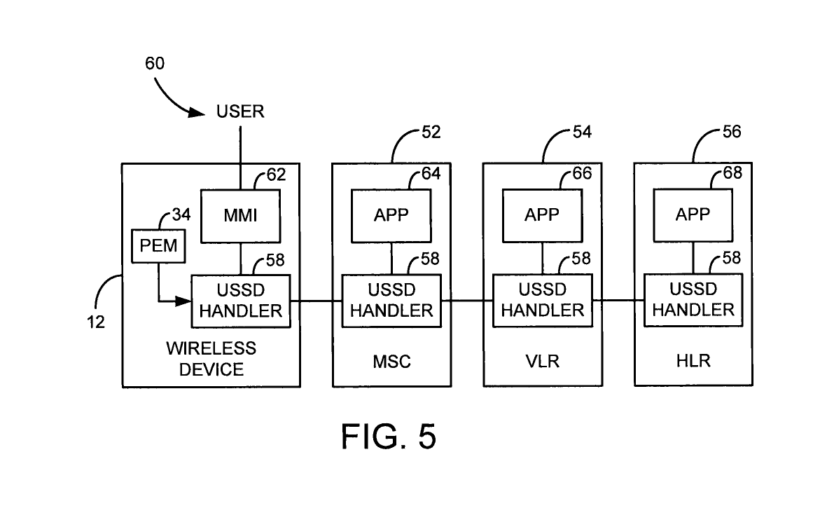

FIG. 5 shows an exemplary set of address information for multiple PEMCs stored in an exemplary PEMC table 45. This specific example of a PEMC table 45 shows the wireless device 12 having obtained the IP address of the PEMC, for example, using DHCP 46. However, the wireless device 12 may also determine and/or store, for example, a logical name for the PEMC 42 that the wireless device 12 translates into an IP address using DNS, or other logical representations of the PEMC address, or just such logical representations statically configured 48.

The following tables illustrate an exemplary implementation to enable the provisioning of the information on priority, type of PEMC that are reachable, the addresses of the PEMCs that are reachable, and specific PEM information to GPRS and the EPC.

TABLE 1
ACTIVATE PDP CONTEXT ACCEPT message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Transaction identifier | Transaction identifier | M | V | ½- 3/2 |
| | | 10.3.2 | | | |
| | Activate PDP context | Message type | M | V | 1 |
| | accept message identity | 10.4 | | | |
| | Negotiated LLC SAPI | LLC service access point | M | V | 1 |
| | | identifier 10.5.6.9 | | | |
| | Negotiated QoS | Quality of service | M | LV | 13-17 |
| | | 10.5.6.5 | | | |
| | Radio priority | Radio priority | M | V | ½ |
| | | 10.5.7.2 | | | |
| | Spare half octet | Spare half octet | M | V | ½ |
| | | 10.5.1.8 | | | |
| 2B | PDP address | Packet data protocol | O | TLV | 4-20 |
| | | address | | | |
| | | 10.5.6.4 | | | |
| 27 | Protocol configuration | Protocol configuration | O | TLV | 3-253 |
| | options | options | | | |
| | | 10.5.6.3 | | | |
| 34 | Packet Flow Identifier | Packet Flow Identifier | O | TLV | 3 |
| | | 10.5.6.11 | | | |
| 39 | SM cause | SM cause 2 | O | TLV | 3 |
| | | 10.5.6.6a | | | |
| | Emergency Service | Service Category | M | TLV | 3 |
| | Category | 10.5.4.33 | | | |
| | Emergency Service | Emergency Service Priority | O | | |
| | Priority | X.Y.Z.A | | | |
| | Emergency Service | Service Category | O | | |
| | Requested | 10.5.4.33 | | | |
| | Emergency Servers | Emergency Servers X.Y.Z.C | O | | |
| | Emergency Service | Emergency Service | O | | |
| | Periodicity | Periodicity X.Y.Z.D | | | |
| | Emergency Number List | Emergency Number List | O | | |
| | | 10.5.3.13 | | | |
| | PEM Information | Protocol configuration | O | | |
| | | options 10.5.6.3 | | | |

TABLE 2
ACTIVATE DEDICATED EPS BEARER CONTEXT REQUEST message content

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction | Procedure transaction | M | V | 1 |
| | identity | identity | | | |
| | | 9.4 | | | |
| | Activate dedicated EPS | Message type | M | V | 1 |
| | bearer context request | 9.8 | | | |
| | message identity | | | | |
| | Linked EPS bearer | Linked EPS bearer identity | M | V | ½ |
| | identity | 9.9.4.6 | | | |
| | Spare half octet | Spare half octet | M | V | ½ |
| | | 9.9.2.9 | | | |
| | EPS QoS | EPS quality of service | M | LV | 2-10 |
| | | 9.9.4.3 | | | |
| | TFT | Traffic flow template | M | LV | 2-256 |
| | | 9.9.4.16 | | | |
| 5D | Transaction identifier | Transaction identifier | O | TLV | 3-4 |
| | | 9.9.4.17 | | | |
| 30 | Negotiated QoS | Quality of service | O | TLV | 14-18 |
| | | 9.9.4.12 | | | |
| 32 | Negotiated LLC SAPI | LLC service access point | O | TV | 2 |
| | | identifier | | | |
| | | 9.9.4.7 | | | |
| 8- | Radio priority | Radio priority | O | TV | 1 |
| | | 9.9.4.13 | | | |
| 34 | Packet flow Identifier | Packet flow Identifier | O | TLV | 3 |
| | | 9.9.4.8 | | | |
| 27 | Protocol configuration | Protocol configuration | O | TLV | 3-253 |
| | options | options | | | |
| | | 9.9.4.11 | | | |
| | Emergency Service | Service Category | M | TLV | 3 |
| | Category | 10.5.4.33 | | | |
| | Emergency Service | Emergency Service Priority | O | | |
| | Priority | X.Y.Z.A | | | |
| | Emergency Service | Service Category | O | | |
| | Requested | 10.5.4.33 | | | |
| | Emergency Servers | Emergency Servers X.Y.Z.C | O | | |
| | Emergency Service | Emergency Service | O | | |
| | Periodicity | Periodicity X.Y.Z.D | | | |
| | Emergency Number List | Emergency Number List | O | | |
| | | 10.5.3.13 | | | |
| | PEM Information | Protocol configuration | O | | |
| | | options 10.5.6.3 | | | |

This IE can be included if the network wants to indicate which emergency services (e.g. PEM) are reachable through the PDP context or PDN connection.

In certain scenarios, when the wireless device 12 connects to a certain PDN, either for emergency services or for normal connectivity, the network 41, which may be a PDN gateway or an application residing in the PDN gateway or a PEMC 42 alerted by the PDN gateway that the wireless device 12 is now connected, may trigger the wireless device 12 to send PEM 34, such as by, for example, providing a PEM Request. The network 41 can also provide the address of the PEMC 42 to the wireless device 12, in the form of an actual address, for example, an IP address for PEM 34 transport on the user plane. Also, the network 41 can provide the address of the PEMC 42 to the wireless device 12 in the form of a set of information that the wireless device 12 can use to determine the address of the PEMC 42, for example, a Fully Qualified Domain Name (FQDN) of the PEMC 42 that the wireless device 12 can use to query the DNS to obtain one or more IP addresses of one or more PEMCs 42. The network 41 can also provide PEM-Information indicating the type of information the wireless device should include in the PEMs, including, for example, whether a single PEM 34 should be sent or whether periodic PEMs 34 can be sent, including indications of the periodicity. The signalling protocol used by the PEMC 42 to trigger the PEM transmission by the wireless device 12 could include SIP and can be based on 3GPP IMS mechanism.

In case of session-based PEM transmission, the wireless device 12 and/or the PEMC 42 use a signalling protocol to exchange information and establish the exchange of PEMs 34. An example of signalling protocol is SIP, and the 3GPP IMS infrastructure can be used to establish the PEM session.

Transmission of PEM on Control Plane

The PEM 34 can be sent as a special NAS message. In the case of E-UTRAN, the PEM can be transmitted on an Signalling Radio Bearer (SRB) such as in an RRC message uplink (UL) direct transfer that encapsulates this NAS message, and the eNB can route it to the appropriate MME on the S1 bearer established for this wireless device 12. The RRC establishment cause or attach cause can indicate to the network 41 that the connection being requested is for emergency purposes. In this case, no special PDN connection other than the default PDN connection is required because the MME receives the PEM 34 via SRB2/S1 and routes it to the emergency service access point. SRBs are set up with the highest priority and infinite prioritized bit rate (PBR). This allows entities such as the MME to be aware of the contents of the PEM message and to use these contents accordingly.

Transmission of PEM 34 in limited service state may be permitted, for example, subject to local regulations. If the wireless device 12 is not attached, the wireless device 12 could perform an Emergency Attach to the network, for example, as defined in 3GPP TS 23.401 for the case of E-UTRAN, GERAN and UTRAN connected to the EPC. The PEM 34 has a new establishment cause that is included in the Emergency Attach or in the connection establishment request message. The authentication and verification procedures are bypassed based on this establishment cause when the wireless device 12 is in limited service state. The network can include Emergency Service Category IE in the ATTACH ACCEPT to inform the wireless device 12 of the types of emergency services that are supported. Also, the network can include Emergency Service Category IE in the TRACKING AREA UPDATE ACCEPT to inform the wireless device 12 of the types of emergency services that are supported. Further still, the network can include Emergency Service Category IE in the TRACKING AREA UPDATE ACCEPT to inform the wireless device 12 of the types of emergency services are supported. Further still, the network can include Emergency Service Category IE in the ROUTING AREA UPDATE ACCEPT to inform the wireless device 12 of the types of emergency services are supported. Other information that can also be transported, such as described in the previous messages.

In case of transmission of PEM 34 over the control plane, the wireless device 12 may or may not need to know the IP address of the PEMC 42 to which the PEM needs to be sent. If the wireless device is configured to know the address, the wireless device 12 can send the PEM to the address of the PEMC, otherwise the network 41 (e.g. the MME or SGSN) upon receiving t a PEM from the wireless device can derive and use the address based on a combination of the wireless device identity, the information contained in the PEM, local policies, or other information. The network can provide or not the address to the wireless device. The PEM 34 may be sent over the control plane also to enable the PEM 41 usage by other entities in the wireless network 41 closer to the MME or the SGSN.

Unstructured Supplementary Service Data (USSD)

3GPP networks provide, in the CS domain, USSD service as a facility to transparently exchange information between an USSD Application in the wireless device 12 to a USSD Application residing in one or more network 41 elements, which is part of the 3GPP architecture or provided as an external server. USSD can be used by the wireless device 12 to provide the PEMs 34 to the network 41.

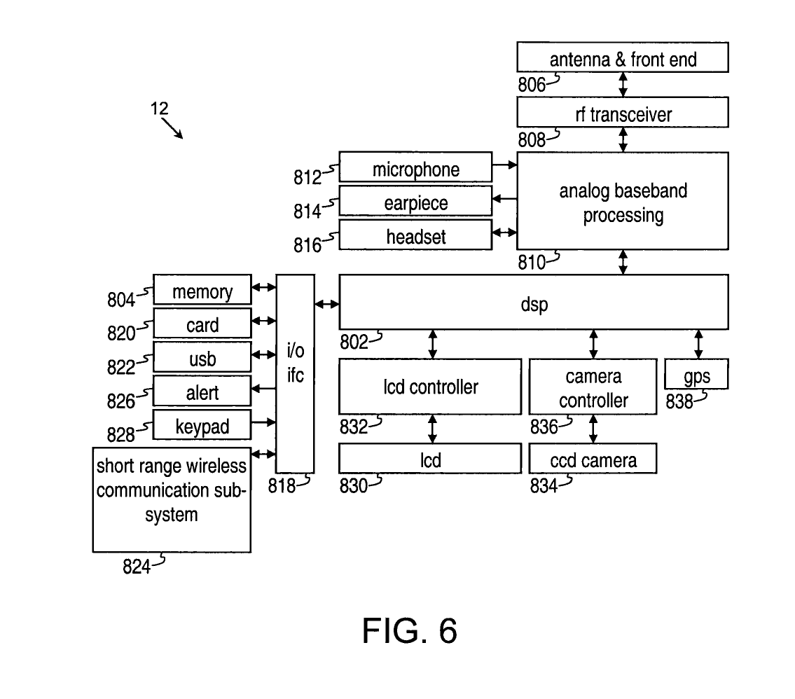

The architecture for USSD services is shown in FIG. 6. As illustrated, the wireless device 12, the Mobile Switching Centre (MSC) 52, Visitor location register (VLR) 54, and home location register (HLR) 56, the USSD Handler 58 has routing functionality to route the USSD messages as communicated by a user 60 through a machine man interface (MMI) 62 appropriately to the applications 64, 66, 68 of the MSC 52, VLR 54, and HLR 56, respectively. USSD information exchanges can be either wireless device-initiated or network-initiated. The USSD application 64, 66, 68 in the network can at any time initiate fetching of information from the USSD Application in the wireless device 12.

It is noted that, in order to use USSD as a bearer for PEM 34, the PEMC should be an application 64, 66, 68 running on a network node that is connected using Signalling System #7 (SS7) to the 3GPP network nodes, depending on the type of architecture.

The PEM 34 can also be sent by the wireless device 12 by embedding the PEM 34 in an SMS message or a set of concatenated SMS messages. In this way, the PEM 34 can be transported over SMS both in a control-plane embodiment, when SMS is exchanged in NAS signalling as in current GERAN/UTRAN implementation and in the E-UTRAN CSFB-based embodiment, and in a user-plane embodiment when either SMS over IP or SMS over IMS is used. In order to support PEM transport over SMS, a mechanism for the discovery of PEMC is provided. Since SMS addressing is based on Mobile Subscriber ISDN Number (MSISDNs), in order for the wireless device 12 to send PEMs using SMS as a transport, the wireless device 12 discovers the MSISDN of the PEMC. This can be achieved by either an operator configuring the wireless device 12 to use a specific PEMC MSISDN by providing a configuration object containing one or more PEMC addresses, or by providing the wireless device 12 with the MSISDN of one or more PEMCs to use upon attach or during IMS registration.

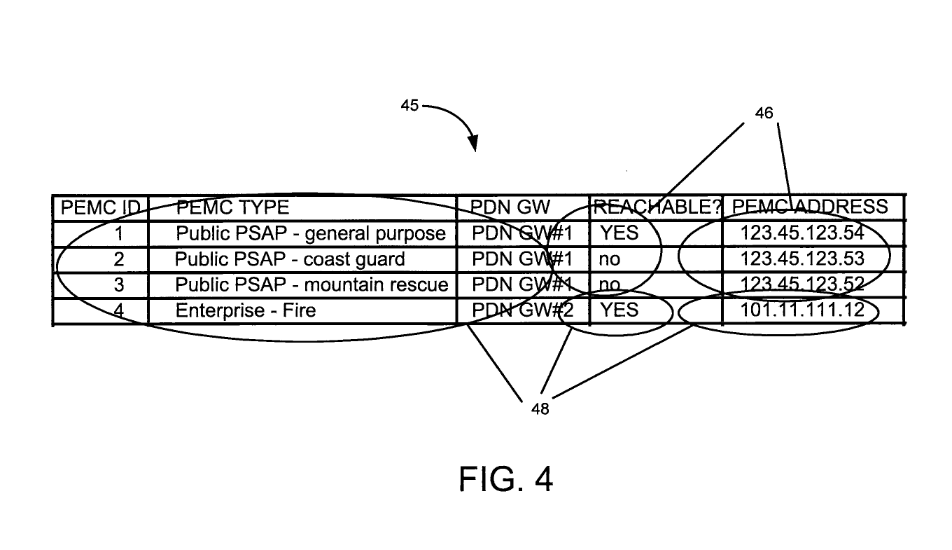

As described above with respect to FIG. 4, in certain scenarios when the wireless device 12 connects to the network 41, such as over the CS domain, either for emergency services or for normal connectivity, the network 41 may trigger the wireless device 12 to send PEM 34 messages by, for example, providing a PEM Request. The network 41 can also provide the address of the PEMC 42 to the wireless device 12, for example an MSISDN for PEM 34 transport over SMS, at this time. The network 41 can also provide PEM-Information indicating what type of information the wireless device 12 should include in the PEMs, including, for example, whether a single PEM 34 should be sent or whether periodic PEMs 34 can be sent, including possibly indication of the periodicity. The PEM Request can be, for example, transported in NAS signalling or using SMS or USSD wherein the network (e.g. a PEMC, the MME or the SGSN sends the request though an SMS to the wireless device, or the PEMC triggers the MME or the SGSN to send a NAS request to the UE containing the PEM request.

Emergency-dependent PDN Connection and PDN GW/PSAP Selection and Discovery of Supported Emergency Services

A new emergency service type may be provided for the PEM 34. The new “PEM” emergency service type can be defined as a new value for the Emergency Category or as a specific Emergency Type Emergency APN or a string used to enrich the Emergency APN. For example, when the wireless device is requesting PDN connectivity for emergency bearer services, the wireless device can provide either an Emergency APN specific to the emergency service required, or an Emergency APN enriched with an indication of the type of emergency service required, or an Emergency Service Category IE to indicate the type of emergency service required.

The network provides to the wireless device an indication of the supported emergency services. The emergency service type supported by the network can be defined as a new value for the Emergency Category. Also, the network includes the Emergency Number List containing a list of emergency numbers, for example a list of MSISDNs, The network includes the Emergency Number list for example if the Emergency Service Category indicates PEM over SMS is supported to provide the MSISDN of the PEM recipient.

The following tables illustrate an exemplary implementation to enable the applicability of the Emergency Category to GPRS and the EPC.

TABLE 3
ACTIVATE PDP CONTEXT REQUEST message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Transaction identifier | Transaction identifier | M | V | ½- 3/2 |
| | | 10.3.2 | | | |
| | Activate PDP context | Message type | M | V | 1 |
| | request message identity | 10.4 | | | |
| | Requested NSAPI | Network service access | M | V | 1 |
| | | point identifier 10.5.6.2 | | | |
| | Requested LLC SAPI | LLC service access point | M | V | 1 |
| | | identifier 10.5.6.9 | | | |
| | Requested QoS | Quality of service | M | LV | 13-17 |
| | | 10.5.6.5 | | | |
| | Requested PDP address | Packet data protocol | M | LV | 3-19 |
| | | address | | | |
| | | 10.5.6.4 | | | |
| 28 | Access point name | Access point name | O | TLV | 3-102 |
| | | 10.5.6.1 | | | |
| 27 | Protocol configuration | Protocol configuration | O | TLV | 3-253 |
| | options | options 10.5.6.3 | | | |
| A- | Request type | Request type | O | TV | 1 |
| | | 10.5.6.17 | | | |
| | Emergency Category | Service Category | O | TLV | 3 |
| | | 10.5.4.33 | | | |

TABLE 4
PDN CONNECTIVITY REQUEST message content

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction | Procedure transaction | M | V | 1 |
| | identity | identity | | | |
| | | 9.4 | | | |
| | PDN connectivity request | Message type | M | V | 1 |
| | message identity | 9.8 | | | |
| | Request type | Request type | M | V | ½ |
| | | 9.9.4.14 | | | |
| | PDN type | PDN type | M | V | ½ |
| | | 9.9.4.10 | | | |
| D- | ESM information transfer | ESM information transfer | O | TV | 1 |
| | flag | flag | | | |
| | | 9.9.4.5 | | | |
| 28 | Access point name | Access point name | O | TLV | 3-102 |
| | | 9.9.4.1 | | | |
| 27 | Protocol configuration | Protocol configuration | O | TLV | 3-253 |
| | options | options | | | |
| | | 9.9.4.11 | | | |
| | Emergency Category | Service Category | O | TLV | 3 |
| | | X.Y.Z.W | | | |

TABLE 5
ATTACH REQUEST message content

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Attach request message | Message type | M | V | 1 |
| | identity | 9.8 | | | |
| | EPS attach type | EPS attach type | M | V | ½ |
| | | 9.9.3.11 | | | |
| | NAS key set identifier | NAS key set identifier | M | V | ½ |
| | | 9.9.3.21 | | | |
| | EPS mobile identity | EPS mobile identity | M | LV | 5-12 |
| | | 9.9.3.12 | | | |
| | UE network capability | UE network capability | M | LV | 3-14 |
| | | 9.9.3.34 | | | |
| | ESM message container | ESM message container | M | LV-E | 2-n |
| | | 9.9.3.15 | | | |
| 19 | Old P-TMSI signature | P-TMSI signature | O | TV | 4 |
| | | 10.5.5.8 | | | |
| 50 | Additional GUTI | EPS mobile identity | O | TLV | 13 |
| | | 9.9.3.12 | | | |
| 52 | Last visited registered | Tracking area identity | O | TV | 6 |
| | TAI | 9.9.3.32 | | | |
| 5C | DRX parameter | DRX parameter | O | TV | 3 |
| | | 9.9.3.8 | | | |
| 31 | MS network capability | MS network capability | O | TLV | 4-10 |
| | | 9.9.3.20 | | | |
| 13 | Old location area | Location area identification | O | TV | 6 |
| | identification | 9.9.2.2 | | | |
| 9- | TMSI status | TMSI status | O | TV | 1 |
| | | 9.9.3.31 | | | |
| 11 | Mobile station classmark 2 | Mobile station classmark 2 | O | TLV | 5 |
| | | 9.9.2.4 | | | |
| 20 | Mobile station classmark 3 | Mobile station classmark 3 | O | TLV | 2-34 |
| | | 9.9.2.5 | | | |
| 40 | Supported Codecs | Supported Codec List | O | TLV | 5-n |
| | | 9.9.2.10 | | | |
| | Emergency Category | Service Category | M | TLV | 3 |
| | | A.B.C.D | | | |

The Emergency Category IE is included in the message to indicate the type of emergency Service Category to which the request relates.

TABLE 6
ATTACH ACCEPT message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Skip indicator | Skip indicator | M | V | ½ |
| | | 10.3.1 | | | |
| | Attach accept message | Message type | M | V | 1 |
| | identity | 10.4 | | | |
| | Attach result | Attach result | M | V | ½ |
| | | 10.5.5.1 | | | |
| | Force to standby | Force to standby | M | V | ½ |
| | | 10.5.5.7 | | | |
| | Periodic RA update timer | GPRS Timer | M | V | 1 |
| | | 10.5.7.3 | | | |
| | Radio priority for SMS | Radio priority | M | V | ½ |
| | | 10.5.7.2 | | | |
| | Radio priority for TOM8 | Radio priority 2 | M | V | ½ |
| | | 10.5.7.5 | | | |
| | Routing area | Routing area identification | M | V | 6 |
| | identification | 10.5.5.15 | | | |
| 19 | P-TMSI signature | P-TMSI signature | O | TV | 4 |
| | | 10.5.5.8 | | | |
| 17 | Negotiated READY timer | GPRS Timer | O | TV | 2 |
| | value | 10.5.7.3 | | | |
| 18 | Allocated P-TMSI | Mobile identity | O | TLV | 7 |
| | | 10.5.1.4 | | | |
| 23 | MS identity | Mobile identity | O | TLV | 7-10 |
| | | 10.5.1.4 | | | |
| 25 | GMM cause | GMM cause | O | TV | 2 |
| | | 10.5.5.14 | | | |
| 2A | T3302 value | GPRS Timer 2 | O | TLV | 3 |
| | | 10.5.7.4 | | | |
| 8C | Cell Notification | Cell Notification | O | T | 1 |
| | | 10.5.5.21 | | | |
| 4A | Equivalent PLMNs | PLMN List | O | TLV | 5-47 |
| | | 10.5.1.13 | | | |
| B- | Network feature support | Network feature support | O | TV | 1 |
| | | 10.5.5.23 | | | |
| 34 | Emergency Number List | Emergency Number List | O | TLV | 5-50 |
| | | 10.5.3.13 | | | |
| A- | Requested MS | Requested MS Information | O | TV | 1 |
| | Information | 10.5.5.25 | | | |
| 37 | T3319 value | GPRS Timer 2 | O | TLV | 3 |
| | | 10.5.7.4 | | | |
| 38 | T3323 value | GPRS Timer 2 | O | TLV | 3 |
| | | 10.5.7.4 | | | |
| | Emergency Number List | Emergency Number List | O | | |
| | | 10.5.3.13 | | | |
| | Emergency Category | Service Category | M | TLV | 3 |
| | | 10.5.4.33 | | | |

TABLE 7
ACTIVATE PDP CONTEXT ACCEPT message content

| IEI | Information Element | Type/Reference | Presence | Format | Length |
|---|---|---|---|---|---|
| | Protocol discriminator | Protocol discriminator | M | V | ½ |
| | | 10.2 | | | |
| | Transaction identifier | Transaction identifier | M | V | ½- 3/2 |
| | | 10.3.2 | | | |
| | Activate PDP context | Message type | M | V | 1 |
| | accept message identity | 10.4 | | | |
| | Negotiated LLC SAPI | LLC service access point | M | V | 1 |
| | | identifier 10.5.6.9 | | | |
| | Negotiated QoS | Quality of service | M | LV | 13-17 |
| | | 10.5.6.5 | | | |
| | Radio priority | Radio priority | M | V | ½ |
| | | 10.5.7.2 | | | |
| | Spare half octet | Spare half octet | M | V | ½ |
| | | 10.5.1.8 | | | |
| 2B | PDP address | Packet data protocol | O | TLV | 4-20 |
| | | address | | | |
| | | 10.5.6.4 | | | |
| 27 | Protocol configuration | Protocol configuration | O | TLV | 3-253 |
| | options | options | | | |
| | | 10.5.6.3 | | | |
| 34 | Packet Flow Identifier | Packet Flow Identifier | O | TLV | 3 |
| | | 10.5.6.11 | | | |
| 39 | SM cause | SM cause 2 | O | TLV | 3 |
| | | 10.5.6.6a | | | |
| | Emergency Service | Service Category | M | TLV | 3 |
| | Category | 10.5.4.33 | | | |
| | Emergency Service | Emergency Service Priority | O | | |
| | Priority | X.Y.Z.A | | | |
| | Emergency Service | Service Category | O | | |
| | Requested | 10.5.4.33 | | | |
| | Emergency Servers | Emergency Servers X.Y.Z.C | O | | |
| | Emergency Service | Emergency Service | O | | |
| | Periodicity | Periodicity X.Y.Z.D | | | |
| | PEM Information | Protocol configuration | O | | |
| | | options 10.5.6.3 | | | |

TABLE 8
ATTACH ACCEPT message content

| IEI | Information Element | Type/Reference | Presence | Format | Length |
|---|---|---|---|---|---|
| | Protocol discriminator | Protocol discriminator | M | V | ½ |
| | | 9.2 | | | |
| | Security header type | Security header type | M | V | ½ |
| | | 9.3.1 | | | |
| | Attach accept message | Message type | M | V | 1 |
| | identity | 9.8 | | | |
| | EPS attach result | EPS attach result | M | V | ½ |
| | | 9.9.3.10 | | | |
| | Spare half octet | Spare half octet | M | V | ½ |
| | | 9.9.2.9 | | | |
| | T3412 value | GPRS timer | M | V | 1 |
| | | 9.9.3.16 | | | |
| | TAI list | Tracking area identity list | M | LV | 7-97 |
| | | 9.9.3.33 | | | |
| | ESM message container | ESM message container | M | LV-E | 2-n |
| | | 9.9.3.15 | | | |
| 50 | GUTI | EPS mobile identity | O | TLV | 13 |
| | | 9.9.3.12 | | | |
| 13 | Location area | Location area identification | O | TV | 6 |
| | identification | 9.9.2.2 | | | |
| 23 | MS identity | Mobile identity | O | TLV | 7-10 |
| | | 9.9.2.3 | | | |
| 53 | EMM cause | EMM cause | O | TV | 2 |
| | | 9.9.3.9 | | | |
| 17 | T3402 value | GPRS timer | O | TV | 2 |
| | | 9.9.3.16 | | | |
| 59 | T3423 value | GPRS timer | O | TV | 2 |
| | | 9.9.3.16 | | | |
| 4A | Equivalent PLMNs | PLMN list | O | TLV | 5-47 |
| | | 9.9.2.8 | | | |
| 34 | Emergency number list | Emergency number list | O | TLV | 5-50 |
| | | 9.9.3.37 | | | |
| 64 | EPS network feature | EPS network feature | O | TLV | 3 |
| | support | support | | | |
| | | 9.9.3.12A | | | |
| | Emergency Category | Service Category | M | TLV | 3 |
| | | A.B.C.D | | | |

The Emergency Category UE is included in the message to indicate the type of Emergency Service Category supported by the network. The Emergency Service Category IE indicates the type of emergency services for which the wireless device is permitted to request activation of emergency PDN connections. Also, the network includes the Emergency Number List containing a list of emergency numbers, for example a list of MSISDNs, The network includes the Emergency Number list for example if the Emergency Service Category indicates PEM over SMS is supported to provide the MSISDN of the PEM recipient

TABLE 9
TRACKING AREA UPDATE ACCEPT message content

| IEI | Information Element | Type/Reference | Presence | Format | Length |
|---|---|---|---|---|---|
| | Protocol discriminator | Protocol discriminator 9.2 | M | V | ½ |
| | Security header type | Security header type 9.3.1 | M | V | ½ |
| | Tracking area update | Message type | M | V | 1 |
| | accept message | 9.8 | | | |
| | identity | | | | |
| | EPS update result | EPS update result | M | V | ½ |
| | | 9.9.3.13 | | | |
| | Spare half octet | Spare half octet | M | V | ½ |
| | | 9.9.2.9 | | | |
| 5A | T3412 value | GPRS timer | O | TV | 2 |
| | | 9.9.3.16 | | | |
| 50 | GUTI | EPS mobile identity | O | TLV | 13 |
| | | 9.9.3.12 | | | |
| 54 | TAI list | Tracking area identity list | O | TLV | 8-98 |
| | | 9.9.3.33 | | | |
| 57 | EPS bearer context | EPS bearer context | O | TLV | 4 |
| | status | status | | | |
| | | 9.9.2.1 | | | |
| 13 | Location area | Location area | O | TV | 6 |
| | identification | identification | | | |
| | | 9.9.2.2 | | | |
| 23 | MS identity | Mobile identity | O | TLV | 7-10 |
| | | 9.9.2.3 | | | |
| 53 | EMM cause | EMM cause | O | TV | 2 |
| | | 9.9.3.9 | | | |
| 17 | T3402 value | GPRS timer | O | TV | 2 |
| | | 9.9.3.16 | | | |
| 59 | T3423 value | GPRS timer | O | TV | 2 |
| | | 9.9.3.16 | | | |
| 4A | Equivalent PLMNs | PLMN list | O | TLV | 5-47 |
| | | 9.9.2.8 | | | |
| 34 | Emergency number | Emergency number list | O | TLV | 5-50 |
| | list | 9.9.3.37 | | | |
| 64 | EPS network feature | EPS network feature | O | TLV | 3 |
| | support | support | | | |
| | | 9.9.3.12A | | | |
| | Emergency Category | Service Category | M | TLV | 3 |
| | | A.B.C.D | | | |

This IE can be included in the message to indicate the type of Emergency Service Category supported by the network. The Emergency Service Category IE indicates the type of emergency services for which the wireless device permitted allowed to request activation of emergency PDN connections.

TABLE 10
ACTIVATE DEDICATED EPS BEARER CONTEXT REQUEST message content

| IEI | Information Element | Type/Reference | Presence | Format | Length |
|---|---|---|---|---|---|
| | Protocol discriminator | Protocol discriminator | M | V | ½ |
| | | 9.2 | | | |
| | EPS bearer identity | EPS bearer identity | M | V | ½ |
| | | 9.3.2 | | | |
| | Procedure transaction | Procedure transaction | M | V | 1 |
| | identity | identity | | | |
| | | 9.4 | | | |
| | Activate dedicated EPS | Message type | M | V | 1 |
| | bearer context request | 9.8 | | | |
| | message identity | | | | |
| | Linked EPS bearer | Linked EPS bearer identity | M | V | ½ |
| | identity | 9.9.4.6 | | | |
| | Spare half octet | Spare half octet | M | V | ½ |
| | | 9.9.2.9 | | | |
| | EPS QoS | EPS quality of service | M | LV | 2-10 |
| | | 9.9.4.3 | | | |
| | TFT | Traffic flow template | M | LV | 2-256 |
| | | 9.9.4.16 | | | |
| 5D | Transaction identifier | Transaction identifier | O | TLV | 3-4 |
| | | 9.9.4.17 | | | |
| 30 | Negotiated QoS | Quality of service | O | TLV | 14-18 |
| | | 9.9.4.12 | | | |
| 32 | Negotiated LLC SAPI | LLC service access point | O | TV | 2 |
| | | identifier | | | |
| | | 9.9.4.7 | | | |
| 8- | Radio priority | Radio priority | O | TV | 1 |
| | | 9.9.4.13 | | | |
| 34 | Packet flow Identifier | Packet flow Identifier | O | TLV | 3 |
| | | 9.9.4.8 | | | |
| 27 | Protocol configuration | Protocol configuration | O | TLV | 3-253 |
| | options | options | | | |
| | | 9.9.4.11 | | | |
| | Emergency Service | Service Category | M | TLV | 3 |
| | Category | 10.5.4.33 | | | |
| | Emergency Service | Emergency Service Priority | O | | |
| | Priority | X.Y.Z.A | | | |
| | Emergency Service | Service Category | O | | |
| | Requested | 10.5.4.33 | | | |
| | Emergency Servers | Emergency Servers X.Y.Z.C | O | | |
| | Emergency Service | Emergency Service | O | | |
| | Periodicity | Periodicity X.Y.Z.D | | | |
| | PEM Information | Protocol configuration | O | | |
| | | options 10.5.6.3 | | | |

For 3GPP access, some aspects are addressed herein in order for the wireless device 12 to provide the Emergency Category to the network 41 so that the correct PGW (PDN Gateway) and PSAPs 16 or intermediate signalling server or network entry point (e.g. P-CSCF) are selected.

First, in UTRAN/GERAN in GPRS, the PDP context activation and Secondary PDP context activation are extended to allow the wireless device 12 to provide the Emergency Category information in order for the wireless device 12 to provide information specific to the current emergency when additional PDN connectivity is established. The GGSN may also provide the Emergency Category during network initiated PDP context activation. Thus, when an Emergency Category is provided by the wireless device in GPRS, the Emergency Category may be provided to the GGSN to enable the GGSN to select the correct PSAP/PEMC to be used for the emergency service. When an Emergency Category is provided by the wireless device in GPRS, the SGSN may map the Emergency Category to a specific APN to retrieve the appropriate information for the selection of the GGSN from the information obtained from the HSS. The mapping can, for example, be based on translating the Emergency Category into a well-known string and selecting from information obtained from the HSS the corresponding APN

Moreover, in EPC/E-UTRAN, the ATTACH REQUEST and the PDN CONNECTIVITY REQUEST are extended to allow the wireless device 12 to provide the Emergency Category information. This is based on the use of Emergency Type Emergency APNs specific to the emergency service type. The wireless device 12 is configured with a list of Emergency Type Emergency APNs, one for each type of emergency (e.g. police, fire brigade). This allows the wireless device 12 to provide information specific to the current emergency when it attaches to the EPC and when additional PDN connectivity is established. Thus, for emergency services, the wireless device can provide either an Emergency APN specific to the emergency service required, or an Emergency APN enriched with an indication of the type of emergency service required, and/or an Emergency Service Category.

Additionally, when in GERAN/UTRAN or in EPC/E-UTRAN and the wireless device 12 is connected to a first PDN for a first emergency service (e.g. police), if the wireless device 12 needs to connect to a second emergency service (e.g. fire brigade) either after the first connection is over or in parallel, the wireless device 12 provides the Emergency Category information for the second type of emergency service in order for the wireless device to provide information specific to the second type of emergency. Thus, an Emergency APN enrichment is created by which the wireless device 12, when requiring connectivity for a specific type of emergency, uses the Emergency APN (possibly chosen and provided to the wireless device by the PLMN operator—could be HPLMN or Visited PLMN (VPLMN)) and enriches such Emergency APN by providing an indication of the type of emergency. This can be achieved by, for example, concatenating a string (configured in the wireless device by the operator) to the original APN, such as “APN.fire-brigade.”

Furthermore, the MME or comparable network element may insert location information of cell identifier. Typically, the MME receives some location information from H(e)NB or comparable network element. The P-GW or comparable network element may use this location information to select a signalling server such as a P-CSCF. In another embodiment, the P-GW may provide this location information to a PSAP (e.g. via intermediate network elements such as the P-CSCF). It is advantageous to select a signalling server that is known to be able to route a request to at least one PSAP that serves the location of the wireless device.

An IMS Specific Configuration in the GGSN/P-GW may be desired. The GGSN/P-GW can have a list of preconfigured addresses of signalling servers (P-CSCF servers). For requests that are not emergency service requests, this list can be provided to the wireless device on request. For requests that are emergency service requests (as defined in 3GPP TS 24.301), this list can be provided. It may be possible to pre-configure the list per APN. If one or more lists is preconfigured with addresses of signalling servers capable of handling emergency service requests, separate lists may exist for one or more cell identifiers (see 3GPP TS 24.008, subclause 10.5.1.1) and one or more emergency service categories (see 3GPP TS 24.008, subclause 10.5.4.33). If a request includes a cell identifier or emergency service category, a list of preconfigured addresses of signalling servers can be returned that corresponds with the indicated cell identifier or emergency service category. When an MS/UE indicates an emergency in a Create PDP Context Request message on GERAN/UTRAN or for E-UTRAN in initial access request (e.g. Attach Request, PDN Connectivity Request), the GGSN/P-GW can respond with one or more P-CSCF server addresses in accordance with subclause 13a.2.1 per 3GPP TS 29.061. When an MS/UE indicates an emergency in a Create PDP Context Request message on GERAN/UTRAN or for E-UTRAN in initial access request (e.g. Attach Request, PDN Connectivity Request), the GGSN/P-GW can provide the IMS signalling flag to explicitly indicate to the wireless device the intention of using the PDP context/EPS bearer for IMS related signalling, if dedicated PDP contexts/EPS Bearers for IMS signalling are supported.

Moreover, the wireless device provides in the PDP context activation in UTRAN/GERAN in GPRS and in the ATTACH REQUEST and the PDN CONNECTIVITY REQUEST in EPC/E-UTRAN an emergency APN. The emergency APN can be a preconfigured APN provided by the operator to the wireless device, or a well-known APN, or can be constructed by the wireless device by selecting any of the APNs known to the wireless device and attaching a well-known string that identifies the APN as an emergency APN. Thus, when an emergency APN is provided by the wireless device in GPRS or EPC/E-UTRAN, the emergency APN may be provided to the GGSN to enable the GGSN to select the correct PSAP/PEMC to be used for the emergency service. Alternatively, the SGSN or the MME can map the emergency APN to an Emergency Category that is provided to the GGSN to enable the GGSN to select the correct PSAP/PEMC to be used for the emergency service. When an emergency APN is provided by the wireless device in GPRS or EPC/E-UTRAN, the SGSN or MME retrieves the appropriate information for the selection of the GGSN or PDN GW from the information obtained from the HSS and from information stored in the SGSN or MME.

For non-3GPP access, when DSMIPv6 is used for the S2c interface, the wireless device 12 discovers the PDN gateway (in this case a Home Agent (HA)) using the mechanisms 3) and 4) (i.e. DHCP or DNS) defined as described in the following extract from 3GPP TS 23.402:

“For the S2c reference point, the wireless device needs to know the IP address of the PDN Gateway for the PDN the wireless device wants to connect to. This address is made known to the wireless device using one of the following methods:

1) Via PCO at the attach procedure or wireless device requested PDN Connectivity procedure, for 3GPP access (as defined in TS 23.401) or trusted non-3GPP access (if supported).

2) Via IKEv2 during tunnel setup to ePDG.

3) If the IP address of the PDN GW is not received using options 1-2 above and if the wireless device knows that the HA is in the PDN where the wireless device is attached to then the wireless device can request a PDN Gateway address via DHCP draft-ietf-mip6-bootstrapping-integrated-dhc.

4) If the IP address of the PDN GW is not delivered using options 1-3 above the wireless device can interact directly with the Domain Name Service function by composing a FQDN corresponding to the PDN.”

First, the Protocol Configuration Options (PCO) mechanism in 1), where the wireless device 12 provides an Emergency Category indication in a PCO to the network 41 is utilized to select the address of an appropriate HA. For mechanism (4), in the DNS lookup defined in IETF RFC 5026 one of two options are provided. In the first option, either the wireless device 12 composes an Emergency FQDN as defined in 3GPP TS 23.003 for the case of DSMIPv6 in the HA-APN case including the Emergency Category indication, so that the DNS network can select an appropriate PDN gateway for the type of emergency required. Specifically, the DNS may return a list of records corresponding to different HAs (e.g. if the wireless device provided an Emergency Category indication without specifying any specific type of emergency service). For each record returned, the DNS provides an Emergency Category to indicate which emergency service is supported by the HA corresponding to such record. The Emergency Category can indicate one or more emergency services supported. In the second option, the wireless device 12 may, alternatively, construct an Emergency FQDN as defined in 3GPP TS 23.003 for the case of DSMIPv6 in the HA-APN case but using a generic label (e.g. “emergency”) and queries the DNS providing such FQDN. In such cases, DNS returns a list of PDN gateways with one or more entries, and for each entry the DNS provides an Emergency Category to indicate which emergency service is supported by each PDN gateway. The Emergency Category can indicate one or more emergency services supported.

The DHCP mechanism in 3) described in 3GPP TS 23.402 is based on the wireless device 12 requesting a PDN Gateway address via DHCP draft-ieff-mip6-bootstrapping-integrated-dhc and supporting the stateless DHCPv6 as specified in IETF RFC 3736 and the DHCPv6 options as specified in draft-ietf-mip6-hiopt. A second approach proposed is that the wireless device 12 provides an Emergency Category indication (e.g. the Emergency Category defined in the appendix as enhancement of the Service Category defined in 3GPP TS 24.008) in the DHCP Request the wireless device 12 sends to discover the address of the PDN GW to be used for the emergency service. The wireless device 12 can as an example include the Emergency Category indication in the Home Network Identifier Option defined in draft-ietf-mip6-hiopt, or can provide an HA-APN as defined in 3GPP TS 23.003 and constructed as described in the second approach.

To implement such, 3GPP TS 23.003 is modified to clarify that the HA-APN is composed of three parts, the third of which is an Emergency Category Identifier. The Emergency Category Identifier is composed of one label “emergency” to identify that the wireless device is attempting to discover the address of a HA to support emergency services. Alternatively, the Emergency Category Identifier is derived from the Emergency Category information element defined in 3GPP TS 24.008 and is composed of one label. The label may be composed as a sequence of 8 characters “0” or “1” mapped from the Emergency Service Category Value (octet 3) in the Emergency Category, where the meaning is:

Bit 1 Police

Bit 2 Ambulance

Bit 3 Fire Brigade

Bit 4 Marine Guard

Bit 5 Mountain Rescue

Bit 6 manually initiated eCall

Bit 7 automatically initiated eCall

Bit 8 Packetized Emergency Message

The wireless device may set one or more bits to “1”. If more than one bit is set to “1”, an HA-APN address is selected that enables connection to a combined Emergency centre (e.g. ambulance and fire brigade in Japan) or to all types of Emergency centres corresponding to the bits set to “1” by the wireless device. If more than one bit is set to “1”, the MME can select a PDN GW that enables connection to a combined Emergency centre (e.g. ambulance and fire brigade in Japan) or to both types of Emergency centres.

If no bit is set to “1”, an HA-APN address is selected that enables connection to an operator defined default emergency centre. If no bit is set to “1”, the MME can select a default emergency PDN GW for the emergency bearer.

Alternatively, the Emergency Category Identifier may be derived from the Emergency Category information element defined in 3GPP TS 24.008 and may be composed of eight labels, six are provided for example:
First label: “nil” or “Police”
Second label: “nil” or “Ambulance”
Third label: “nil” or “Fire Brigade”
Fourth label: “nil” or “Marine Guard”
Fifth label: “nil” or “Mountain Rescue”
Sixth label: “nil” or “Packetized Emergency Message”

The wireless device may set one or more labels to a value different from “nil”. In such case, an HA-APN address may be selected that enables connection to a combined Emergency centre (e.g. ambulance and fire brigade in Japan) or to all types of Emergency centres corresponding to the labels set to a value different from “nil” by the wireless device. The IETF RFC 5031 defines more emergency service types. The emergency service category field may be used not only for the S2c case, in which case other fields may also be included. On the other hand RFC 5031 does not specify how combined Emergency centres can be indicated. For example, co-pending U.S. application Ser. No. 12/131,779, entitled “CODING AND BEHAVIOR WHEN RECEIVING AN IMS EMERGENCY SESSION INDICATOR FROM AUTHORIZED SOURCE,” provides some examples and options that can be utilized when combined Emergency centres use URNs and is hereby incorporated by reference in its entirety. The emergency service category field is used not only for the S2c case and may contain other fields. If no label is set by the wireless device to a value different from “nil”, an HA-APN address is selected that enables connection to an operator defined default emergency centre. Alternatively, an IE can be used to indicate that the value is populated or set. Such would distinguish messages sent by legacy wireless devices from wireless devices that have been enabled in accordance with at least one embodiment in this paper.

Thus, in these situations, the wireless device 12, during the initial attach on S2c and wireless device-initiated connectivity to additional PDN on S2c, provides an Emergency Category information, for example, in the S2c DSMIPv6 Binding Update message in order for the PDN GW to select the PSAP or the PEMC, and to be aware of what type of emergency service is required.

When the PDN gateway returns a Binding Acknowledgment (BA) message, the PDN gateway return the Emergency Category indication of the emergency supported, Emergency Service Priority, Emergency Service Requested in BA. The PDN gateway, based optionally on the Emergency Category the wireless device may have provided, provides the Emergency Category information to indicate that the requested emergency services (e.g. PEM) is reachable through the PDN connection. The PDN gateway, based optionally on the Emergency Category the wireless device may have provided, provides the Emergency Service Priority information to indicate the priority of the PDN connection regarding the emergency services reachable through the PDN connection. The PDN gateway, based optionally on the Emergency Category the wireless device may have provided, provides the Emergency Service Requested to indicate to the wireless device that the emergency service supported (e.g. PEM) can be provided over this PDN connection in addition to other PDN connections the wireless device may be using for the emergency service.

For non-3GPP access, when the wireless device 12 connects to a network 41 using the S2b interface, the wireless device connects first to an Evolved Packet Data Gateway (ePDG) using IKEv2 signalling protocol to establish and IPSec tunnel. The wireless device 12 may provide the Emergency Service category in the IKEv2 IPSec establishment procedure to indicate to the network the type of emergency service requested. Upon receiving the Emergency Service category, the ePDG selects a PDN GW based on the information provided by the wireless device, similarly to what has been described for the MME selection of the PDN GW and the SGSN selection of a GGSN. In the establishment of the S2b tunnel between the ePDG and the PDN GW, the Emergency Category may be provided to the PDN GW to enable the PDN GW to select the correct PSAP/PEMC to be used for the emergency service. When an Emergency Category is provided by the wireless device in non-3GPP access, the ePDG may map the Emergency Category to a specific APN to retrieve the appropriate information for the selection of the PDN GW from the information obtained from the HSS. The mapping can, for example, be based on translating the Emergency Category into a well-known string and selecting from information obtained from the HSS the corresponding APN. When the network completes the IKEv2 procedure for establishment of the IPSec tunnel with the ePDG, the network 41 returns the Emergency Category indication of the emergency supported, Emergency Service Priority, Emergency Service Requested in BA. The network 41, based optionally on the Emergency Category the wireless device may have provided, provides the Emergency Category information to indicate that the requested emergency services (e.g. PEM) is reachable through the PDN connection. The network 41, based optionally on the Emergency Category the wireless device may have provided, provides the Emergency Service Priority information to indicate the priority of the PDN connection regarding the emergency services reachable through the PDN connection. The network 41, based optionally on the Emergency Category the wireless device may have provided, provides the Emergency Service Requested to indicate to the wireless device that the emergency service supported (e.g. PEM) can be provided over this PDN connection in addition to other PDN connections the wireless device may be using for the emergency service.

Packetized Voice Note (PVN) Field

Referring back to FIG. 3, an optional field in the PEM 34 can possibly include either a pre-set or a recorded voice-note 70. The user can record a “voice note” in real time when it needs to be sent, or such a voice note can exist from initial set up (like voice mail “out of office” message set up). This voice note can provide the identity of the user and any emergency contact or medical information. A voice note recorded in real time or pre-recorded could have a special indicator saying that it is an “Emergency Voice Note” (EVN). Once the EVN is recorded, the wireless device immediately encapsulates this in a PEM 34 and transmits it to the network 41. The wireless device 12 can provide the PVN 70 upon attach to the network 41 (e.g. in GPRS or EPC), during RAU or TAU procedures, or at any time PEM 34 can be sent and the wireless device 12 decides a previously transmitted value of the PVN 70 needs to be updated.

The discovery of the PEMC 42 performed by the wireless device 12 considers whether the wireless device 12 needs to include a PVN 70 or not, since not all PEMCs 42 may be able to support the PVN 70. Where the PEM 34 is retransmitted periodically, the PVN 70 as well as other “static” fields may be excluded in subsequent transmissions.

Network Indication of PEM Support

The network 41 can indicate its support for PEM 34 in the system information, in dedicated signalling, or in attach request response or registration request response messages or PDN connection response message when a new PDN connection is established or PDP context activation response when a new PDP context is activated. As such, the identification of per-PDN support of PEM 34 is achieved.

It is noted that for PEM embodiments based on transmission of the PEM 34 over the control plane, PEM support is constrained to be consistent over a tracking area list. If the PEM 34 is sent over the user plane, this restriction does not exist. It is further noted that the PSAP 16 should be able to turn off the sending of the PEM 34. This can be realized in dedicated signalling to the wireless device 12 during the emergency service. As an example, the wireless device 12 sends a PEM 34 to the PEMC 42 and receives an indication that no further PEMs 34 can be sent. Alternatively, a PSAP 16 operator may have access to a mobile operator's network (e.g. by means of a secure website) where they can configure whether or not PEMs 34 may be delivered to that PSAP 16 (and/or in what circumstances/conditions may PEMs 34 be delivered—e.g. based on type of emergency, location, whether or not unauthenticated users may send PEMs 34). In response, the mobile operator modifies the provided PEM 34 destination address information, as described above.

Handover Between Emergency Services

When the wireless device 12 performs a handover between a cell that supports VoIMS while it is using IMS emergency services to a cell that does not support VoIMS, but supports PEMs 34, the wireless device 12 terminates the use of the voice emergency call and starts using PEMs 34 directed to the PSAP 16. Alternatively, if the wireless device 12 is involved in emergency services using PEM 34 and moves to a cell that supports VoIMS, the wireless device 12 may decide, for example, based on policies configured in the wireless device 12 by the operator and provided to the wireless device 12 in configuration messages and appropriate management objects or UICC or RUIM stored information, to establish an IMS emergency call (e.g. including voice) in addition or as a replacement to the PEM 34 service. In the event the wireless device is roaming, default procedures may apply.

Turning now to FIG. 6, shows an example block diagram of the wireless device 12 is provided. While a variety of known components of wireless devices 10 are depicted, in an embodiment a subset of the listed components and/or additional components not listed may be included in the wireless device 12. The wireless device 12 includes a processor such as a digital signal processor (DSP) 802, and a memory 804. As shown, the wireless device 12 may further include an antenna and front end unit 806, a radio frequency (RF) transceiver 808, and an analog baseband processing unit 810. In various configurations, wireless device 12 may include additional, optional components as illustrated in FIG. 6. The additional components may include, for example, a microphone 812, an earpiece speaker 814, a headset port 816, an input/output interface 818, a removable memory card 820, a universal serial bus (USB) port 822, a short range wireless communication sub-system 824, an alert 826, a keypad 828, a liquid crystal display (LCD), which may include a touch sensitive surface 830, an LCD controller 832, a charge-coupled device (CCD) camera 834, a camera controller 836, and a global positioning system (GPS) sensor 838. In an embodiment, the wireless device 12 may include another kind of display that does not provide a touch sensitive screen. In an embodiment, the DSP 802 may communicate directly with the memory 804 without passing through the input/output interface 818.

The DSP 802 or some other form of controller or central processing unit operates to control the various components of the wireless device 12 in accordance with embedded software or firmware stored in memory 804 or stored in memory contained within the DSP 802 itself. In addition to the embedded software or firmware, the DSP 802 may execute other applications stored in the memory 804 or made available via information carrier media such as portable data storage media like the removable memory card 820 or via wired or wireless network communications. The application software may comprise a compiled set of machine-readable instructions that configure the DSP 802 to provide the desired functionality, or the application software may be high-level software instructions to be processed by an interpreter or compiler to indirectly configure the DSP 802.

The antenna and front end unit 806 may be provided to convert between wireless signals and electrical signals, enabling the wireless device 12 to send and receive information from a cellular network or some other available wireless communications network or from a peer wireless device 12. In an embodiment, the antenna and front end unit 806 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 806 may include antenna tuning and/or impedance matching components, RF power amplifiers, and/or low noise amplifiers.

The RF transceiver 808 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 810 and/or the DSP 802 or other central processing unit. In some embodiments, the RF transceiver 808, portions of the antenna and front end 806, and the analog baseband processing unit 810 may be combined in one or more processing units and/or application specific integrated circuits (ASICs). The analog baseband processing unit 810 may provide various analog processing of inputs and outputs, for example analog processing of inputs from the microphone 812 and the headset 816 and outputs to the earpiece 814 and the headset 816.

The DSP 802 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 802 may perform modulation, coding, interleaving, and spreading, and for a receiver function the DSP 802 may perform despreading, deinterleaving, decoding, and demodulation. In another embodiment, for example in an orthogonal frequency division multiplexing (OFDM) technology application, for the transmitter function the DSP 802 may perform modulation, coding, interleaving, inverse fast Fourier transforming, and cyclic prefix appending, and for a receiver function the DSP 802 may perform cyclic prefix removal, fast Fourier transforming, deinterleaving, decoding, and demodulation. In other wireless technology applications, yet other signal processing functions and combinations of signal processing functions may be performed by the DSP 802. The DSP 802 may communicate with a wireless network via the analog baseband processing unit 810.

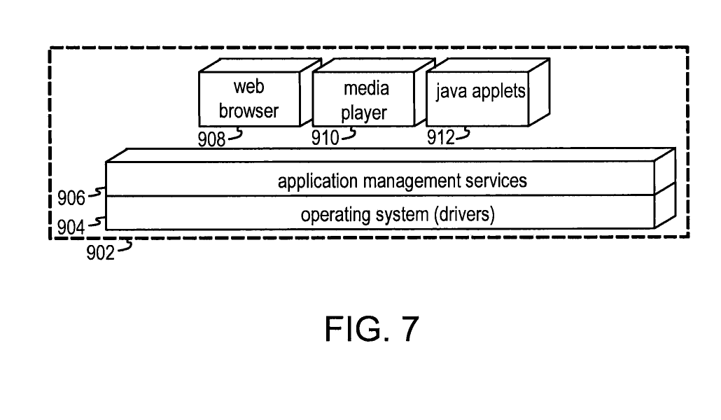

FIG. 7 illustrates a software environment 902 that may be implemented by a processor or controller of the wireless device 12. The software environment 902 includes operating system drivers 904 that are executed by the processor or controller of the wireless device 12 to provide a platform from which the rest of the software operates. The operating system drivers 904 provide drivers for the wireless device hardware with standardized interfaces that are accessible to application software. The operating system drivers 904 include application management services (“AMS”) 906 that transfer control between applications running on the wireless device 12. Also shown in FIG. 8 are a web browser application 908, a media player application 910, and Java applets 912.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made without departing from the spirit and scope disclosed herein.

To apprise the public of the scope of this disclosure, the following claims are made:

1. A method of communicating a packetized emergency message (PEM) from a wireless device to a packetized emergency message consumer (PEMC) comprising the steps of:
receiving an indication that PEM is supported via one of short message service (SMS) and a unstructured supplementary service data (USSD);
discovering an address of a PEMC;
transmitting the PEM to the PEMC via the at least one of SMS and USSD.

2. The method of claim 1 wherein the step of transmitting includes transmitting on a signaling radio bearer (SRB).

3. The method of claim 1 wherein the PEM is transmitted without an identity of the PEMC and without an address of the PEMC.

4. The method of claim 1 wherein the PEM includes a priority indicator.

5. The method of claim 1 further comprising identifying an initiation event that includes a request for a PEM from a network.

6. The method of claim 1 further comprising transmitting multiple PEMs to multiple PEMCs substantially simultaneously.

7. The method of claim 6 further comprising transmitting the PEMs on the SRB.

8. The method of claim 1 further comprising transmitting further PEM to the PEMC.

9. The method of claim 8 wherein further PEM are transmitted upon at least one of an expiration of a predetermined time period and upon identifying a predetermined event.

10. The method of claim 8 wherein the further PEM is substantially similar to the PEM.

11. The method of claim 8 wherein the further PEM includes a portion of the information included in the PEM.

12. The method of claim 1 wherein the PEM includes a voice note.

13. The method of claim 1 wherein PEMC includes a Mobility Management Entity (MME)

14. The method of claim 1 further comprising identifying an initiation event and identifying a PEM for transmission from the wireless device to a PEMC;

15. A method of communicating a packetized emergency message (PEM) from a wireless device over a network to a packetized emergency message consumer (PEMC) comprising the steps of:
identifying a PEM for transmission from the wireless device to a PEMC connected to the network using a signaling system #7 (SS7) protocol; and
using an unstructured supplementary service data (USSD) protocol, transmitting the PEM to the PEMC.

16. The method of claim 15 wherein using the USSD protocol includes interfacing with mobile switching centre (MSC) and home location register (HLR).

17. The method of claim 15 wherein using the USSD protocol includes transmitting multiple PEMs to multiple PEMCs substantially simultaneously.

18. The method of claim 15 further comprising identifying an initiation event that includes a request for a PEM.

19. The method of claim 15 further transmitting further PEM to the PEMC upon at least one of an expiration of a predetermined time period and upon identifying a predetermined event.

20. The method of claim 19 wherein the further PEM includes a portion of the information included in the PEM.

21. The method of claim 15 wherein the PEM includes a voice note.

22. A method of communicating a packetized emergency message (PEM) from a wireless device over a network to a packetized emergency message consumer (PEMC) comprising the steps of:
identifying a PEM for transmission from the wireless device to a PEMC;
identifying an address of the PEMC; and
transmitting the PEM to the PEMC using a short message service (SMS) protocol.

23. The method of claim 22 wherein identifying the address includes identifying a mobile subscriber ISDN number (MSISDN) of the PEMC.

24. The method of claim 23 wherein identifying a MSISDN of the PEMC includes at least one of accessing an operator-configured memory of the wireless device having stored therein the MSISDN and accessing a memory of the wireless device having stored therein the MSISDN received during at least one of an attach process and a internet protocol (IP) Multimedia Subsystem (IMS) registration process.

25. The method of claim 22 wherein transmitting includes transmitting multiple PEMs to multiple PEMCs substantially simultaneously.

26. The method of claim 22 further comprising transmitting further PEM to the PEMC upon at least one of an expiration of a predetermined time period and upon identifying a predetermined event.

27. The method of claim 26 wherein the further PEM includes a portion of the information included in the PEM.

28. The method of claim 22 wherein the PEM includes a voice note.

29. A wireless device configured to communicate a packetized emergency message (PEM) from the wireless device to a packetized emergency message consumer (PEMC) comprising:
a processor configured to:
receive an indication that PEM is supported via one of short message service (SMS) and a unstructured supplementary service data (USSD);
discover an address of a PEMC;
transmit the PEM to the PEMC via the at least one of SMS and USSD.

30. The wireless device of claim 29 wherein the processor is configured to transmit on a signaling radio bearer (SRB) to transmit the PEM.

31. The wireless device of claim 29 wherein the processor is configured to transmit the PEM without an identity of the PEMC and without an address of the PEMC.

32. The wireless device of claim 29 wherein the PEM includes a priority indicator.

33. The wireless device of claim 29 wherein the processor is configured to transmit multiple PEMs to multiple PEMCs substantially simultaneously.

34. The wireless device of claim 33 wherein the processor is configured to transmit the PEM on the SRB.

35. The wireless device of claim 29 wherein the processor is configured to transmit further PEM to the PEMC.

36. The wireless device of claim 35 wherein the processor is configured to transmit the further PEM upon at least one of an expiration of a predetermined time period and upon identifying a predetermined event.

37. The wireless device of claim 35 wherein the further PEM is substantially similar to the PEM.

38. The wireless device of claim 35 wherein the further PEM includes a portion of the information included in the PEM.

39. The wireless device of claim 29 wherein the PEM includes a voice note.
